(19) United States
(12) Patent Application Publication
(10) Pub. No.: US 2025/0247615 A1
(43) Pub. Date: Jul. 31, 2025

(54) IMAGE CAPTURE APPARATUS AND CONTROL METHOD

(71) Applicant: CANON KABUSHIKI KAISHA, Tokyo (JP)

(72) Inventor: TOMOAKI TAKAHASHI, Kanagawa (JP)

(21) Appl. No.: 19/024,310

(22) Filed: Jan. 16, 2025

(30) Foreign Application Priority Data
Jan. 25, 2024 (JP) 2024-009600

(51) Int. Cl. H04N 23/667; H04N 23/63

(52) U.S. Cl. CPC H04N 23/667; H04N 23/63

(57) ABSTRACT

An image capture apparatus controls setting information concerning a display characteristic of content, which is set in the image capture apparatus and a display apparatus connected to the image capture apparatus. When an operation mode of the image capture apparatus is switched from a shooting mode to a reproduction mode, in a case where the number of reproduced contents in the reproduction mode is one, the image capture apparatus controls to change the setting information in accordance with the reproduced content, and in a case where the number of reproduced contents in the reproduction mode is plural, the image capture apparatus controls not to change the setting information in accordance with the reproduced contents.

### BACKGROUND OF THE INVENTION

### Field of the Invention

The present invention relates to a content display control.

### Description of the Related Art

An image capture apparatus such as a digital camera can generate High Dynamic Range (HDR) content with a dynamic range wider than that of conventional Standard Dynamic Range (SDR) content. To display HDR content generated by a digital camera while faithfully reproducing the content, a display apparatus capable of displaying HDR content is necessary.

When an HDR-compatible display apparatus is connected to a digital camera and HDR content output from the digital camera is reproduced and displayed by the display apparatus, it is possible to display the HDR content while faithfully reproducing the color and brightness of the HDR content by making setting information (connection settings) concerning display characteristics such as the color gamut and gamma characteristic of content set in the digital camera and the display apparatus match with the display characteristics of the content to be reproduced.

Japanese Patent Laid-Open No. 2014-229999 describes a technique of calculating a chroma of content and performing gamut conversion so as to match or become closer to the tone of the display apparatus. Japanese Patent Laid-Open No. 2009-064031 describes a technique of correcting original image data based on a virtual gamma curve according to the characteristics of a liquid crystal panel.

In Japanese Patent Laid-Open Nos. 2014-229999 and 2009-064031, since the color gamut and gamma characteristic of content are converted in accordance with the dynamic range that can be displayed by the display apparatus, there might be a case where it may impossible to faithfully express the color and brightness of the original content, such a case makes it difficult to properly evaluate the quality of the content.

### SUMMARY OF THE INVENTION

The present invention has been made in consideration of the aforementioned problems, and realizes techniques capable of suppressing degradation in operability when a plurality of contents are reproduced and displayed on a display apparatus that can faithfully express the quality of content.

In order to solve the aforementioned problems, the present invention provides an image capture apparatus comprising: a mode switching unit that switches to any of a plurality of operation modes including a shooting mode and a reproduction mode; and a control unit that controls setting information concerning a display characteristic of content, which is set in the image capture apparatus and a display apparatus connected to the image capture apparatus, wherein when the operation mode of the image capture apparatus is switched from the shooting mode to the reproduction mode, in a case where the number of reproduced contents in the reproduction mode is one, the control unit controls to change the setting information in accordance with the reproduced content, and in a case where the number of reproduced contents in the reproduction mode is plural, the control unit controls not to change the setting information in accordance with the reproduced contents.

In order to solve the aforementioned problems, the present invention provides a method of controlling an image capture apparatus, the method comprising: switching to any of a plurality of operation modes including a shooting mode and a reproduction mode; and controlling setting information concerning a display characteristic of content, which is set in the image capture apparatus and a display apparatus connected to the image capture apparatus, wherein in the controlling, when the operation mode of the image capture apparatus is switched from the shooting mode to the reproduction mode, in a case where the number of reproduced contents in the reproduction mode is one, control is performed to change the setting information in accordance with the reproduced content, and in a case where the number of reproduced contents in the reproduction mode is plural, control is performed not to change the setting information in accordance with the reproduced content.

According to the present invention, it is possible to suppress degradation in operability when a plurality of contents are reproduced and displayed on a display apparatus that can faithfully express the quality of content.

Further features of the present invention will become apparent from the following description of exemplary embodiments (with reference to the attached drawings).

### BRIEF DESCRIPTION OF THE DRAWINGS

FIGS. 1A and 1B are external views of an image capture apparatus according to the present embodiment.

FIG. 2 is a block diagram illustrating an internal configuration of the image capture apparatus according to the present embodiment.

FIG. 3 is a flowchart illustrating mode switching processing according to the present embodiment.

FIG. 4 is a flowchart illustrating control processing in a shooting mode of FIG. 3.

FIGS. 5A and 5B are flowcharts illustrating control processing in a reproduction mode of FIG. 3.

FIG. 6 is a flowchart illustrating reproduction and display control processing of a selected content of FIGS. 5A and 5B.

FIGS. 7A to 7E are views illustrating transition of connection settings when the operation mode is switched from the shooting mode to the reproduction mode.

FIGS. 8A to 8E are views illustrating transition of connection settings when the selected content is switched in the reproduction mode.

FIGS. 9A to 9E are views illustrating transition of connection settings when the number of displayed contents are switched in the reproduction mode.

FIG. 10 is a flowchart illustrating control processing in a menu mode of FIG. 3.

FIGS. 11A to 11E are views illustrating transition of connection settings when the operation mode is switched from the menu mode to the reproduction mode.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The present embodiment will describe an example of a system in which an image capture apparatus of the present invention is applied to a single-lens reflex digital camera capable of shooting a still image or a moving image (to be also referred to as an image hereinafter) and content such as an image shot by a digital camera 100 is reproduced and displayed on a display apparatus 700.

In the system of the present embodiment, the digital camera 100 and the display apparatus 700 are connected by a cable 710, and it is possible to change setting information (connection settings) concerning display characteristics of content set in the digital camera 100 and the display apparatus 700. In the system of the present embodiment, when the operation mode of the digital camera 100 is switched from a shooting mode to a reproduction mode, in a state in which single content is reproduced and displayed, the connection settings of the digital camera 100 and the display apparatus 700 are changed in accordance with the reproduced content, and in a state in which a plurality of contents are reproduced and displayed, the connection settings of the digital camera 100 and the display apparatus 700 are not changed in accordance with the reproduced contents. In this way, in the display apparatus 700 that can faithfully express the quality, such as the color and brightness, of an image (the quality of content) shot by the digital camera 100, degradation in operability caused by the change of the connection settings for each content is suppressed when reproducing and displaying a plurality of contents.

### Apparatus Configuration

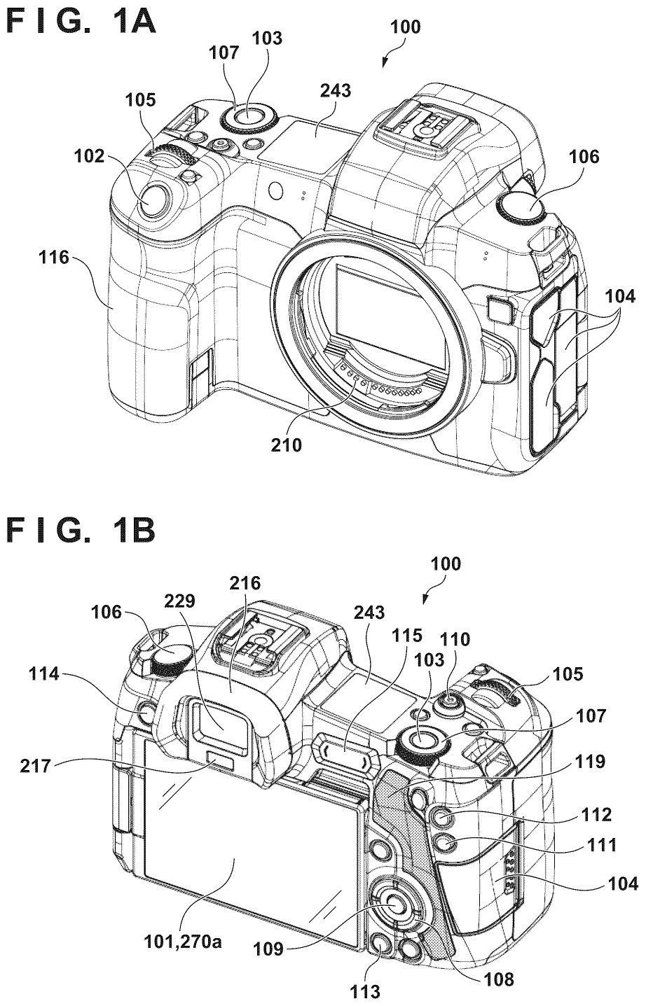

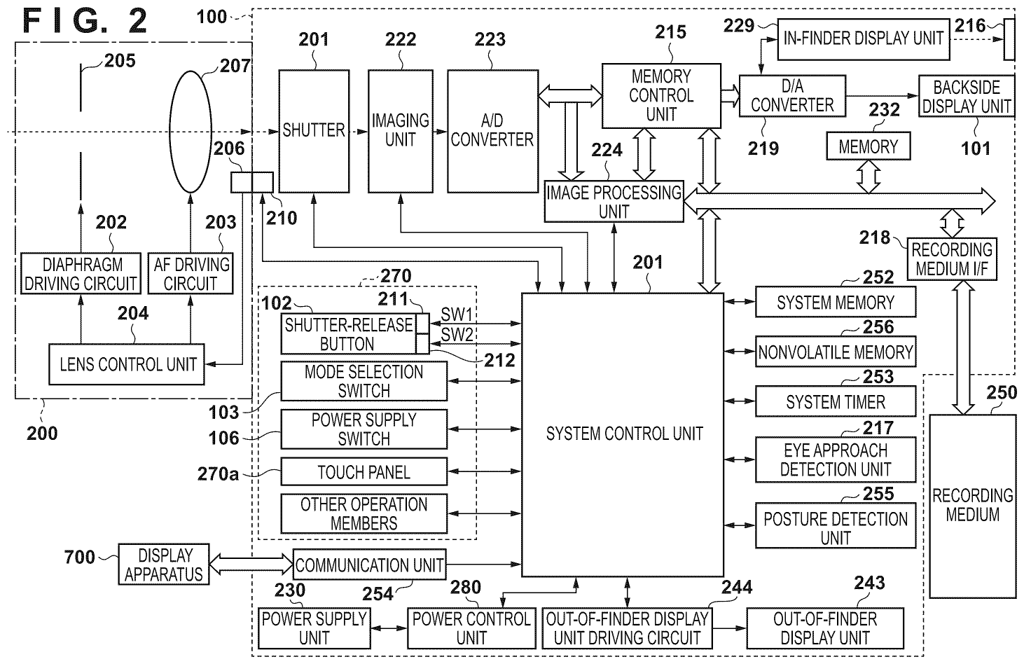

With reference to FIGS. 1A, 1B and 2, the configuration and functions of the digital camera 100 according to the present embodiment will be described.

FIG. 1A is a front perspective view of the digital camera 100 in a state where a lens unit 200 is detached. FIG. 1B is a back perspective view of the digital camera 100.

In FIGS. 1A and 1B, a backside display unit 101 is an out-of-finder display unit for displaying images and various types of information and a display device such as an LCD provided on the back surface of the camera body. Moreover, the backside display unit 101 performs reproducing and displaying a shot still image, a recorded moving image, and performs displaying a live view image such as still image that the camera 100 is capturing or moving image that the camera 100 is recording. A touch panel (touch screen) 270a is provided on the backside display unit 101. The touch panel 270a is a touch operation member capable of detecting contact (touch operation) with the display surface (touch operation surface of the touch panel 270a) of the backside display unit 101.

An out-of-finder display unit 243 is a display device provided on the upper surface of the camera body, and displays various setting values of the camera such as a shutter speed and a diaphragm aperture. A shutter-release button 102 is an operation member for giving a shooting instruction. A mode selection switch 103 is a rotating dial type operation member for switching between various modes. A terminal cover 104 is a cover member for protecting a connector (not illustrated) for connecting an external apparatus such as a display apparatus 700 which will be described later and the digital camera 100 via a cable 710. A main electronic dial 105 is a rotating operation member included in operation units 270 that will be described later with reference to FIG. 2, and by rotating this main electronic dial 105, setting values such as a shutter speed and a diaphragm aperture can be changed.

A power supply switch 106 is an operation member for switching between on/off of the power supply to the digital camera 100. A sub electronic dial 107 is a rotating operation member included in the operation units 270 that will be described later with reference to FIG. 2, and can move a selected frame, scroll images, and/or the like. A cross key 108 is also a movement instruction member included in the operation units 270 that will be described later with reference to FIG. 2, and is a four-directional operation button having push buttons that can be pressed in four directions of up, down, left, and right. The operation can be performed according to the portion of the cross key 108 pressed in the pressed direction. A SET button 109 is also a push button included in the operation units 270 that will be described later with reference to FIG. 2, and is mainly used for determining a selection item and/or the like.

A moving image recording button 110 is also included in operation units 270 that will be described later with reference to FIG. 2, and is used to instruct start and stop of moving image recording. An AE lock button 112 is also included in the operation units 270 that will be described later in FIG. 2, and can fix an exposure state by being pressed in a shooting standby state. The AE lock button 112 functions as a reduction button to reduce a reproduction image and an enlargement magnification of the reproduced image in the reproduction mode.

An enlargement/reduction button 111 is also included in the operation units 270 that will be described later in FIG. 2, and is an operation button for turning on/off of an enlargement mode during a live view image display in the shooting mode. By operating the main electronic dial 105 after turning on of the enlargement mode, the live view image can be enlarged or reduced. In the reproduction mode, the main electronic dial 105 functions as an enlargement button for enlarging a reproduced image and increasing an enlargement ratio.

A reproduction button 113 is also an operation button included in the operation units 270 that will be described later in FIG. 2, and is an operation button for switching the operation mode of the digital camera 100 to the shooting mode or the reproduction mode. By a user pressing the reproduction button 113 during the shooting mode, the operation mode is switched to the reproduction mode, and the latest image among the images recorded on a recording medium 250 can be displayed on the backside display unit 101. A menu button 114 is also included in the operation units 270 that will be described later in FIG. 2, and a menu screen on which various settings can be made can be displayed on the backside display unit 101 by pressing the menu button 114. The user can intuitively perform various settings using the menu screen displayed on the backside display unit 101, the cross key 108 and the SET button 109 or the touch bar 115.

A touch bar 115 (multi-function bar) is also included in the operation units 270 that will be described later in FIG. 2, and is a line-shaped touch operation member (line touch sensor) capable of accepting a touch operation. The touch bar 115 is arranged at a position that can be touched (touchable) by the thumb of the right hand while gripping a grip portion 116 with the right hand so that the shutter-release button 102 can be pressed with the index finger of the right hand (a state of gripping the grip portion with the little finger, the ring finger and the middle finger of the right hand). That is, the touch bar 115 is arranged at a position in which the user can operate the touch bar 115 in a state (shooting posture) where the user is looking through the viewfinder by contacting the eye with the eyepiece part 216 and can press the shutter-release button 102 at any time. The touch bar 115 is capable of accepting a tap operation (an operation of touching and releasing the touch bar 115 without moving a touch position within a predetermined time period), a slide operation to the left and right (an operation of touching the touch bar 115 and moving a touch position while touching the touch bar 115), or the like. The touch bar 115 is an operation member which is different from the touch panel 270a and does not have a display function.

The grip portion 116 has a shape that makes it easy to be grasped by the right hand of the user when the user holds up the digital camera 100. The shutter-release button 102 and the main electronic dial 105 are arranged at positions where the grip portion 116 can be operated by the index finger of the right hand while holding the digital camera 100 by gripping the grip portion 116 with the little finger, the ring finger and the middle finger of the right hand. In the same state, the sub electronic dial 107 and the touch bar 115 are arranged at a position operable with the thumb of the right hand. A lid 117 is a member for opening or closing a slot for mounting/removing the recording medium 250 to/from the digital camera 100.

A communication terminal 210 is an electric contact point for the digital camera 100 to perform communication with the lens unit 200. The eyepiece part 216 is a look-through type eyepiece finder. The user can visually recognize an image displayed on an electronic viewfinder (EVF) which is an in-finder display unit 229 through the eyepiece part 216, and can confirm the focus and composition of the captured object image through the lens unit 200 that will be described later in FIG. 2.

An eye approach detection unit 217 is arranged near the eyepiece part 216, and can detect approach of any object to the eyepiece part 216. As the eye approach detection unit 217, for example, an infrared proximity sensor is used.

A thumb rest portion 119 (thumb waiting position) is a grip member on the back side of the digital camera 100, which is provided at a position where the thumb of the right hand that grips the grip portion 116 is easily placed in a state in which the user does not operate any operation member. The thumb rest portion 119 is comprised of a rubber member or the like for increasing a force for holding the digital camera 10 (grip feeling).

Next, with reference to FIG. 2, the internal configuration of the digital camera 100 and the lens unit 200 of the present embodiment will be described. In FIG. 2, components that are the same as those in FIGS. 1A and 1B are denoted by the same reference numerals.

In FIG. 2, the lens unit 200 is equipped with a shooting lens 207, and is detachable from the digital camera 100. The shooting lens 207 is usually constituted by a plurality of lenses, but is simplified here and is shown by one lens. A communication terminal 206 is an electric contact point for the lens unit 200 to perform communication with the digital camera 100. The communication terminal 210 is an electric contact point for the digital camera 100 to perform communication with the lens unit 200. The lens unit 200 performs communication with a system control unit 201 via the communication terminal 206, and a built-in lens control unit 204 controls a diaphragm driving circuit 202 so as to drive a diaphragm aperture 205, and controls an AF driving circuit 203 so as to displace the position of the shooting lens 207, thereby bringing the object image in focus.

A focal plane shutter 221 can freely control the exposure time of an imaging unit 222 in accordance with an instruction from the system control unit 201. The imaging unit 222 is an image sensor constituted by an image capturing element such as a CCD or a CMOS for converting the object image into an electrical signal. An A/D converter 223 converts an analog signal output from the imaging unit 222 into a digital signal.

An image processing unit 224 performs resizing processing, such as predetermined pixel interpolation and reduction, and color conversion processing, with respect to data from the A/D converter 223 or data from a memory control unit 215. Further, the image processing unit 224 performs predetermined arithmetic processing using the captured image data, and the system control unit 201 performs exposure control and focus control based on the arithmetic results. Thus, AF (Automatic Focus) processing, AE (Automatic Exposure) processing, and EF (flash pre-emission) processing of TTL (Through the Lens) type are performed. Furthermore, the image processing unit 224 performs predetermined arithmetic processing using the captured image data, and AWB (Automatic White Balance) processing of TTL type is performed on the basis of the arithmetic results.

The memory control unit 215 controls to exchange data between the A/D converter 223, the image processing unit 224, and a memory 232. Digital data output from the A/D converter 223 is directly written into the memory 232 via both the image processing unit 224 and the memory control unit 215 or via the memory control unit 215. The memory 232 stores image data obtained from the imaging unit 222 and the A/D converter 223, and display data for displaying the image on the backside display unit 101 or the in-finder display unit 229. The memory 232 has a storage capacity that is sufficient for storing a predetermined number of still images as well as moving images and audio of a predetermined time period. The memory 232 also functions as a memory for image display (video memory).

A D/A converter 219 converts the display data for the image stored in the memory 232 into an analog signal and supplies the backside display unit 101 or the in-finder display unit 229 with the analog signal. The display data for the image that was written into the memory 232 is displayed by the backside display unit 101 or the in-finder display unit 229 via the D/A converter 219. The backside display unit 101 and the in-finder display unit 229 display on the display device in accordance with the analog signal from the D/A converter 219. In this manner, the digital signals stored in the memory 232 are converted into analog signals, and the analog signals are successively transmitted to the backside display unit 101 or the in-finer display unit 229 so as to be displayed thereon, making it possible to function as an electronic view finder (EVF) and to perform live view (LV) image display (through-the lens image display).

Various setting values of the camera such as a shutter speed and the diaphragm aperture for shooting are displayed on the out-of-finder display unit 243 via an out-of-finder display unit driving circuit 244.

A nonvolatile memory 256 is an electrically erasable/recordable memory, and for example, a flash ROM or the like is used. In the nonvolatile memory 256, constants and programs, for example, for operating the system control unit 201 are stored. In this context, “programs” may refer to programs for executing flowcharts that will be described later.

The system control unit 201 is an arithmetic processing device including at least one processor and/or at least one circuit, overall controlling the entire digital camera 100. The system control unit 201 realizes, by executing the programs stored in the nonvolatile memory 256, each process of the flowchart that will be described later. As a system memory 252, for example, RAM is used, and the system memory 252 is used also as a work memory where constants and variables for operating the system control unit 201 and the programs read out from the nonvolatile memory 256 are loaded. The system control unit 201 controls the memory 232, the D/A converter 219, the backside display unit 101, the in-finder display unit 229, and/or the like, so as to perform display control (reproduction control) for generating and displaying display data. The display control (reproduction control) can also generate image data to be output and displayed to the display apparatus 700. A system timer 253 is a time measurement unit for measuring time periods for various types of controls and the time of an inner clock.

The mode selection switch 103, a first shutter switch 211, a second shutter switch 212, and the operation units 270 have switch circuitry for inputting various types of operating instructions to the system control unit 201. The mode selection switch 103 switches the operation mode of the system control unit 201 to any of a still image shooting mode, a moving image recording mode, and a reproduction mode. The still image shooting mode includes an automatic shooting mode, an automatic scene discrimination mode, a manual mode, an aperture-priority mode (Av mode), a shutter speed-priority mode (Tv mode), and a program AE mode (P mode), for example. The still image shooting mode also includes various scene modes each for which scene-specific shooting setting is made, a custom mode, and/or the like.

The user may directly switch to any of these shooting modes by operating the mode selection switch 103, or may switch to any of the shooting modes using another operation member after once being switched to a list screen of the operation modes with the mode selection switch 103 and selecting any of the plurality of shooting modes displayed in the list screen. Similarly, also the moving image recording mode and the reproduction mode may include a plurality of modes.

While the shutter-release button 102 provided on the digital camera 100 is being operated, that is, pressed halfway (the shooting preparation instruction), the first shutter switch 211 is turned on and generates a first shutter switch signal SW1. Upon receiving the first shutter switch signal SW1, the system control unit 201 starts shooting preparation operations such as AF (automatic focus) processing, AE (auto exposure) processing, AWB (auto white balance) processing, and EF (flash pre-emission) processing.

When the operation of the shutter-release button 102 is completed, that is, the shutter-release button 102 is pressed fully (the shooting instruction), the second shutter switch 212 is turned on and generates a second shutter switch signal SW2. Upon receiving the second shutter switch signal SW2, the system control unit 201 starts a series of shooting processing from reading out the signals from the imaging unit 222 to writing of the captured image data as an image file to the recording medium 250.

The operation units 270 include operation members such as various switches and buttons for accepting various operations from a user, and notifying the system control unit 201 of the accepted operations, and include at least the following operation members: the shutter-release button 102, the mode selection switch 103, the main electronic dial 105, the power supply switch 106, the sub electronic dial 107, the cross key 108, the SET button 109, the moving image recording button 110, the enlargement/reduction button 111, the AE lock button 112, the reproduction button 113, the menu button 114 and the touch bar 115.

A power control unit 280 is constituted by, for example, a battery detection circuit, a DC-DC converter, and a switch circuit for changing over the block to be supplied with power, and detects whether a battery has been inserted or not, the type of the battery, and the residual capacity thereof. Further, the power control unit 280 controls the DC-DC converter in accordance with the detection results and an instruction of the system control unit 201, and supplies a necessary voltage for a necessary length of time to each component including the recording medium 250.

A power supply unit 230 comprises a primary battery such as an alkaline battery or a lithium battery, and a secondary battery such as a NiCd battery, a NiMH battery, or a Li-ion battery, or an AC adaptor. A recording medium I/F 218 is for interfacing with the recording medium 250 such as a memory card or a hard disk drive. The recording medium 250 is a recording medium such as a memory card for recording shot images, and is constituted by a semiconductor memory, a magnetic disk, or the like.

A communication unit 254 connects an external apparatus so as to be capable of communication by a wireless antenna or a wired cable, and transmits and receives images and/or sounds. The communication unit 254 can also connect to a wireless LAN (Local Area Network) and the Internet. The communication unit 254 can transmit image data (including a live view image) captured by the imaging unit 222 and an image file recorded on the recording medium 250 to an external apparatus, and can receive image data or other various information from the external apparatus. Note that in the present embodiment, the communication unit 254 has a connection unit which complies with an HDMI®. The display apparatus 700 connected to the communication unit 254 by a cable which complies with an HDMI® can reproduce and display a live view image captured by the imaging unit 222 and images recorded on the recording medium 250. Note that the communication unit 254 is not limited to the wireless LAN, but may use a wireless communication module such as an infrared communication, Bluetooth®, Bluetooth® Low Energy or Wireless USB, or the like.

A posture detection unit 255 detects the posture of the digital camera 100 with respect to the gravity direction. Based on the posture detected by the posture detection unit 255, it is possible to discriminate whether an image captured by the imaging unit 222 has been shot by setting the digital camera 100 in the landscape or portrait orientation. The system control unit 201 can add information about the posture information corresponding to the posture detected by the posture detection unit 255 to the image file, and rotate and record the captured image. An acceleration sensor, gyro sensor or the like may be used as the posture detection unit 255. The posture detection unit 255 can also detect the movement (pan, tilt, lift, rest, etc.) of the digital camera 100 by using the acceleration sensor or the gyro sensor.

Included among the operation units 270 is also the touch panel 270a that is capable of detecting a touch operation on the backside display unit 101. The touch panel 270a and the backside display unit 101 can be constructed as a single integrated unit. For example, the touch panel 270a is constructed in such a manner that the transmittance of light will not interfere with the display presented by the backside display unit 101, and it is attached to the uppermost layer of the display face of the backside display unit 101. In addition, input coordinates on the touch panel 270a and display coordinates on the backside display unit 101 are correlated. As a result, a GUI can be constructed so as to make it possible for the user to directly manipulate the screen displayed on the backside display unit 101. The system control unit 201 is capable of detecting taps, double taps, drags, flicks, pinch-ins, pinch-outs, swipes, etc. onto the touch panel 270a. The touch panel 270a may employ a method that relies upon any of the following: resistive film, electrostatic capacitance, surface acoustic waves, infrared radiation, electromagnetic induction, image recognition and optical sensing. There are methods in which a touch is detected based on contact with the touch panel, as well as methods in which a touch is detected based on approach of a finger or a pen to the touch panel, and any method may be employed.

The eye approach detection unit 217 detects whether an eye (an object) has approached or contacted (eye approaching) or has moved away from (eye detached) the eyepiece part 216 (approach detection). The system control unit 201 switches the backside display unit 101 and the in-finder display unit 229 between displaying (a display state) and not displaying (a non-display state) in accordance with the state detected by the eye approach detection unit 217. The system control unit 201 sets a display destination as the backside display unit 101 and sets the in-finder display unit 229 to be not displaying during non-eye approach detection at least in a case where the shooting mode and the switching of the display destination are automatic. Further, the system control unit 201 sets the display destination as the in-finder display unit 229 and sets the backside display unit 101 to be not displaying during eye approach detection.

If an object has approached, infrared light irradiated from a light emitting unit (not illustrated) of the eye approach detection unit 217 is reflected and is made to be incident on a light receiving unit (not illustrated) of the infrared proximity sensor. In accordance with an incident light amount of the infrared light received by the infrared proximity sensor, it is possible to detect an approach of some kind of physical object to the eyepiece part 216, and discriminate to what level of distance the object has gotten close to the eyepiece part 216 (an eye approaching distance). Upon detecting an approach of an object to the eyepiece part 216, the system control unit 201 can cause display of the in-finder display unit 229 to start. With this, it is possible for the in-finder display unit 229 to display without delay as much as possible when a user looks through the eyepiece part 216.

In addition, upon detecting that an object has approached within a predetermined distance with respect to the eyepiece part 216 from a non-eye approaching state (no approach state), the eye approach detection unit 217 determines that eye approaching is detected and transmits an eye approach detection notification to the system control unit 201. In addition, when an object for which an approach was detected is apart by the predetermined distance or more from an eye approaching state (approach state), the eye approach detection unit 217 determines that eye separation is detected, and an eye separation detection notification is transmitted to the system control unit 201. A threshold for detecting eye approaching and a threshold for detecting eye separation may be made different such as by providing hysteresis for example. In addition, it is assumed that, after eye approaching is detected, there is an eye approaching state until eye separation is detected. In addition, it is assumed that, after eye separation is detected, there is a non-eye approaching state until eye approaching is detected. With this, the system control unit 201 performs display control of the backside display unit 101 and the in-finder display unit 229 in response to an eye approaching state or an eye separation state detected by the eye approach detection unit 217. Note that the eye approach detection unit 217 is not limited to an infrared proximity sensor, and another sensor may be used if it can detect an approach of an object or an eye to be deemed as eye approaching.

### Control Processing

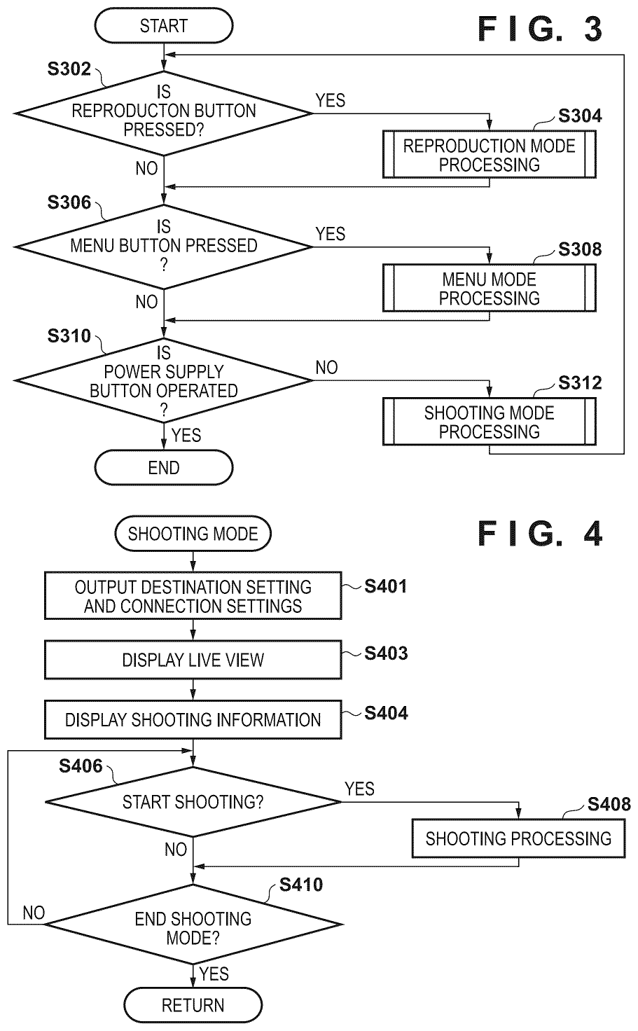

Next, with reference to FIGS. 3 to 11A-11B, processing for controlling connection settings of the digital camera 100 and the display apparatus 700 in accordance with the number of displayed contents according to the present embodiment, will be described.

First, with reference to FIG. 3, mode switching processing by the digital camera 100 according to the present embodiment will be described.

The processing shown in FIG. 3 is implemented when the system control unit 201 controls the respective components of the digital camera 100 by deploying programs stored in the nonvolatile memory 256 to the system memory 252 and executing the programs. The processing shown in FIG. 3 is started when the digital camera 100 is powered on.

In step S302, the system control unit 201 determines whether the reproduction button 113 has been pressed. When it is determined that the reproduction button 113 has been pressed, the system control unit 201 advances the processing to step S304. When it is determined that the reproduction button 113 has not been pressed, the system control unit 201 advances the processing to step S306. Note that in a state where the power of the digital camera 100 is OFF, the digital camera 100 may be powered on by long-pressing the reproduction button 113 instead of the power supply switch 106. In this case, after the digital camera 100 is powered on, it may be determined in step S302 that the reproduction button 113 has been pressed.

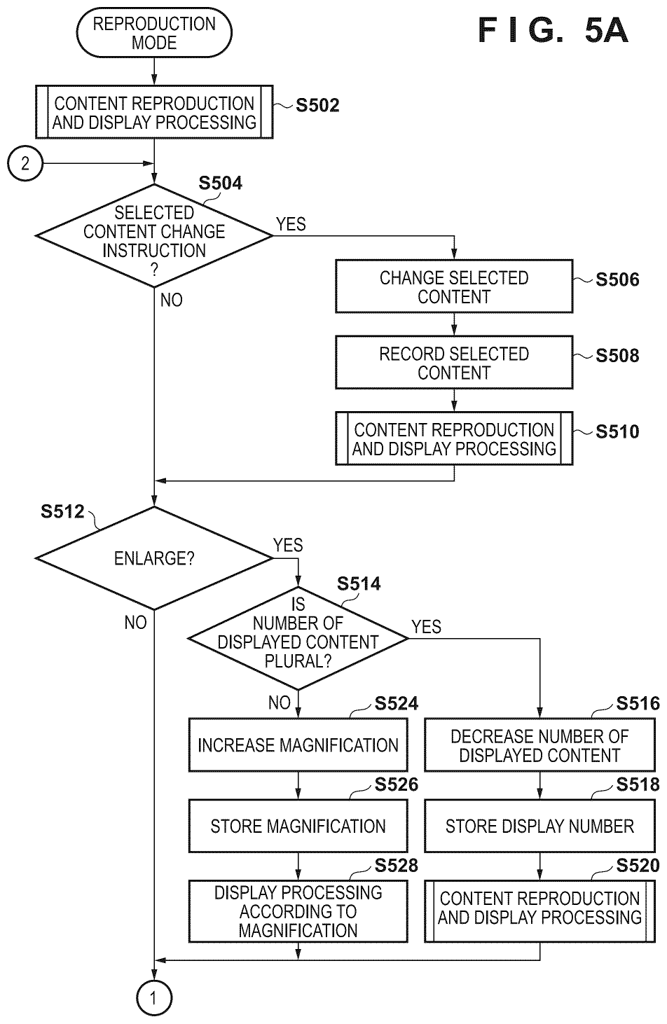

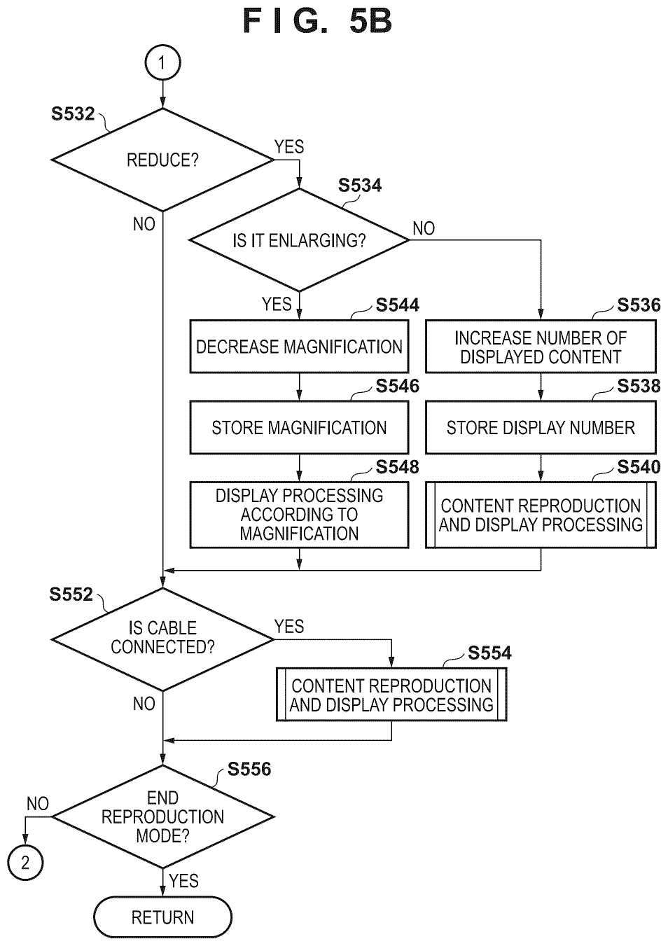

In step S304, the system control unit 201 starts control processing in the reproduction mode that will be described later with reference to FIGS. 5A and 5B.

In step S306, the system control unit 201 determines whether the menu button 114 has been pressed. When it is determined that the menu button 114 has been pressed, the system control unit 201 advances the processing to step S308. When it is determined that the menu button 114 has not been pressed, the system control unit 201 advances the processing to step S310.

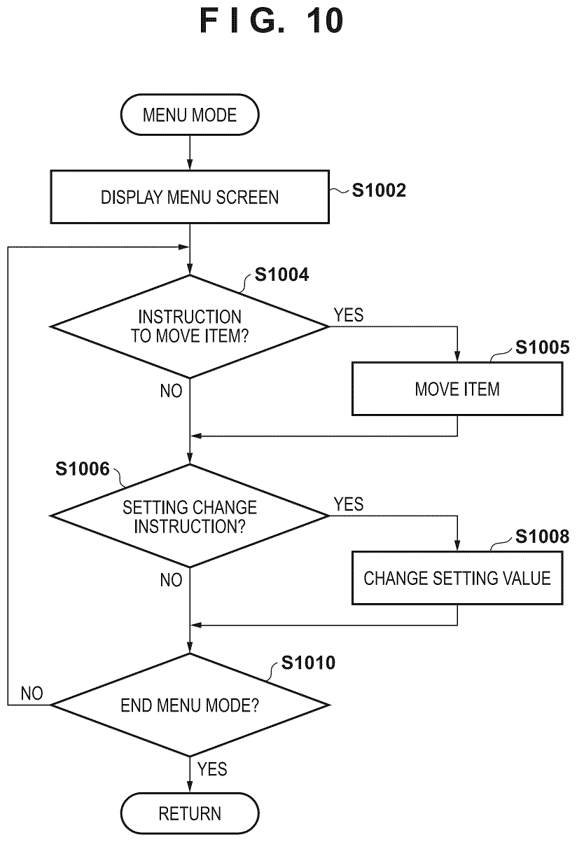

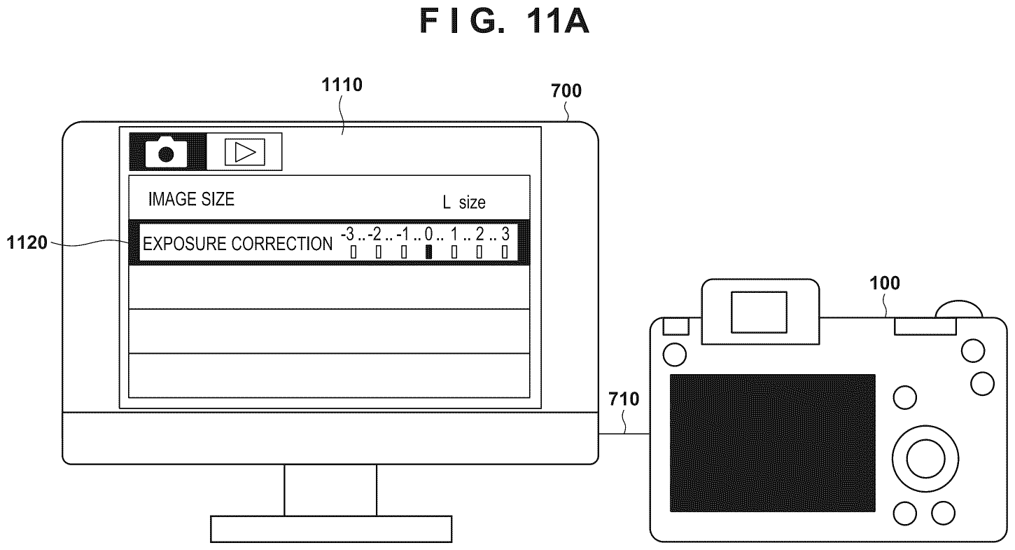

In step S308, the system control unit 201 starts control processing in a menu mode that will be described later with reference to FIG. 10.

In step S310, the system control unit 201 determines whether the power supply switch 106 has been operated. When it is determined that the power supply switch 106 has been operated, the system control unit 201 turns off the power and ends the processing. When it is determined that the power supply switch 106 has not been operated, the system control unit 201 advances the processing to step S312.

In step S312, the system control unit 201 starts control processing in the shooting mode that will be described later with reference to FIG. 4.

### Control Processing in Shooting Mode

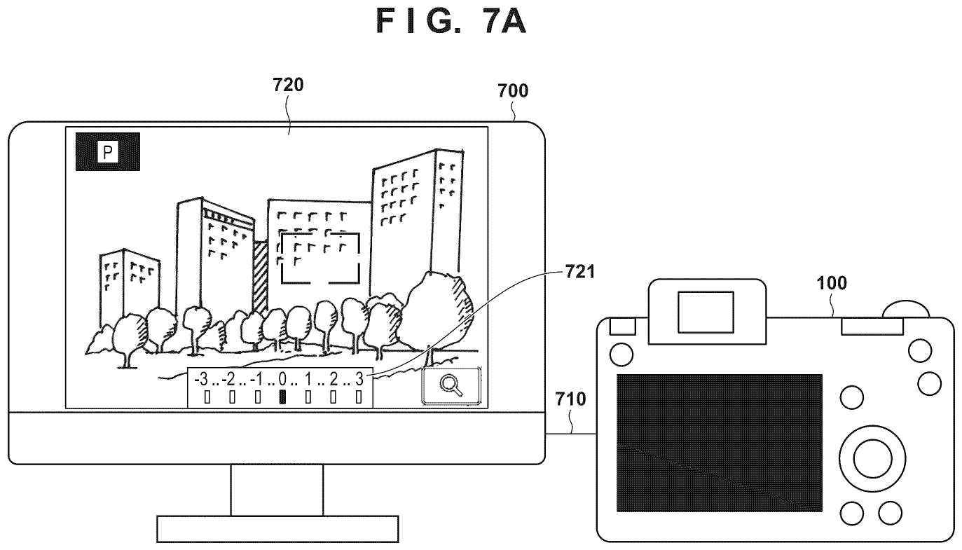

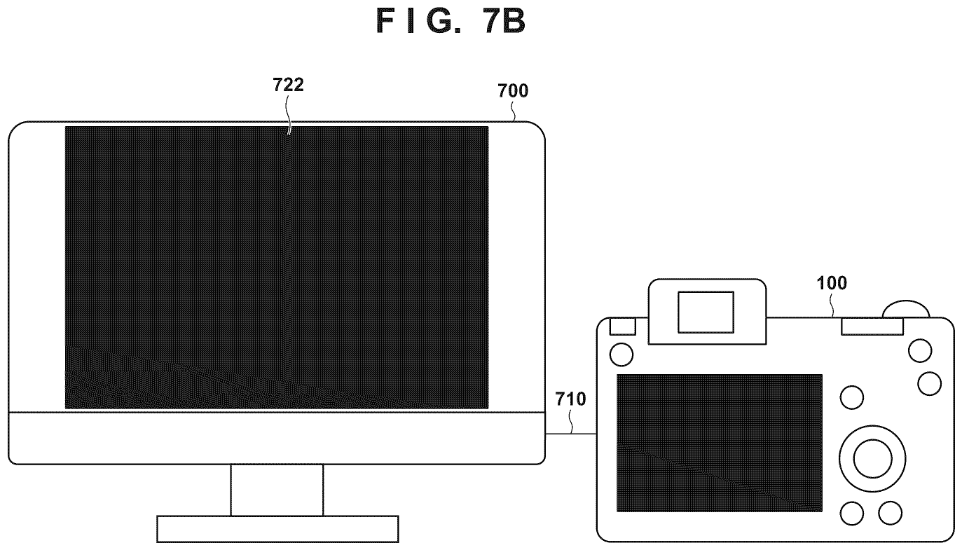

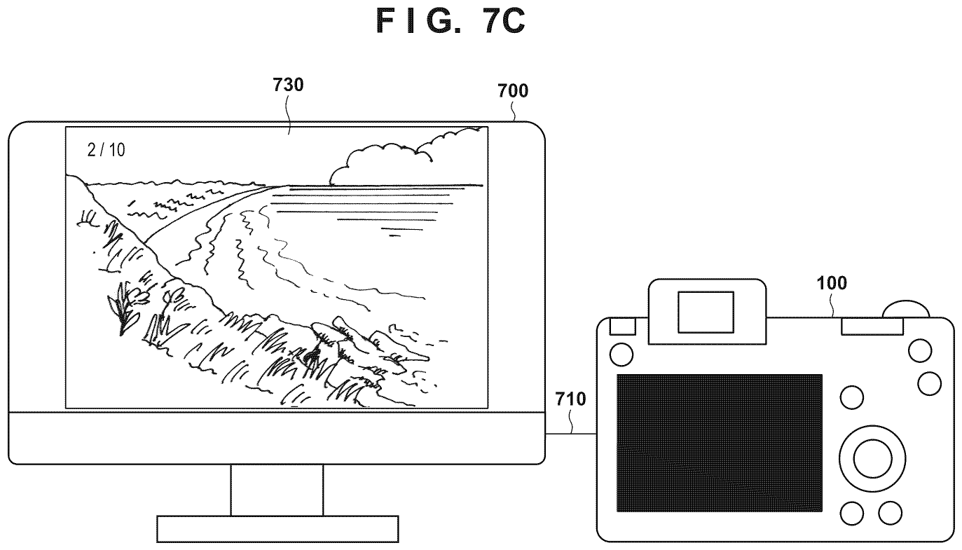

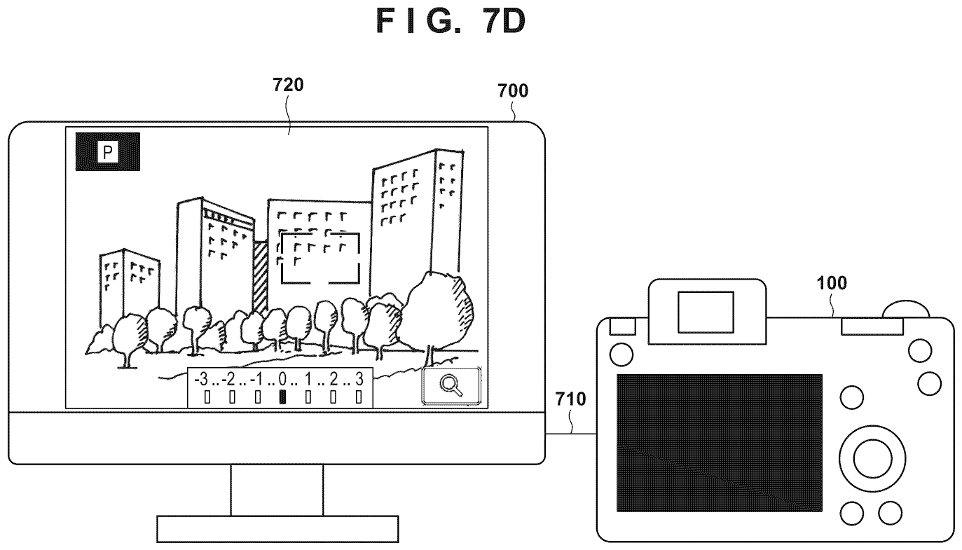

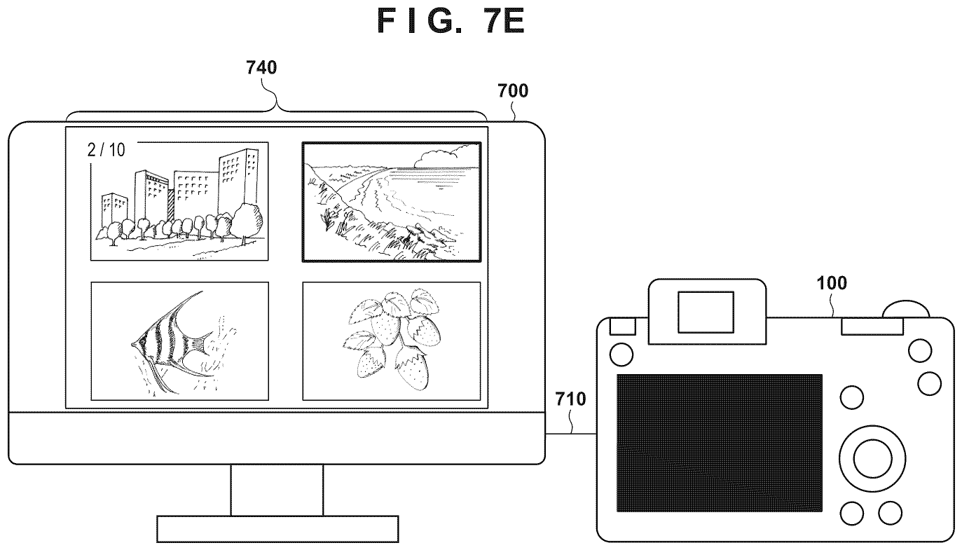

The control processing in the shooting mode in step S312 of FIG. 3 will be described next with reference to FIGS. 4 and 7A.

FIG. 4 is a flowchart illustrating the control processing in the shooting mode in step S312 of FIG. 3.

FIG. 7A illustrates a state in which the digital camera 100 and the display apparatus 700 are connected in the shooting mode.

As shown in FIG. 7A, the digital camera 100 and the display apparatus 700 are connected by the cable 710 complying with an HDMI. One end of the cable 710 is connected to a connector arranged in the terminal cover 104 of the digital camera 100, and the other end is connected to a video input terminal of the display apparatus 700, thereby making it possible to display content output from the digital camera 100 on the display apparatus 700. When the digital camera 100 and the display apparatus 700 are connected by the cable 710, it is possible to change the HDMI connection settings. In the present embodiment, the HDMI connection settings of a color gamut of BT601 and a gamma characteristic of sRGB and the HDMI connection settings of a color gamut of BT2020 and a gamma characteristic of PQ are switched in accordance with the display characteristics of content transmitted to the display apparatus 700 and displayed. Note that the connection settings may be switched to connection settings other than the above connection settings in accordance with the content display characteristics. Note that the content of the present embodiment is a moving image or a still image generated by the digital camera 100 but is not limited to these, and may be content other than the images.

In step S401, the system control unit 201 makes content output destination setting and connection settings. When the digital camera 100 and the display apparatus 700 are not connected, the system control unit 201 sets the backside display unit 101 as the output destination. When the digital camera 100 and the display apparatus 700 are connected, the system control unit 201 sets the display apparatus 700 as the output destination. When the system control unit 201 sets the display apparatus 700 as the output destination, the connection settings of the digital camera 100 and the display apparatus 700 are changed. The connection settings in the shooting mode are set with reference to the shooting parameters of the digital camera 100. For example, the shooting parameters include a color gamut and a gamma characteristic.

In step S403, the system control unit 201 performs control to display a live view image on the output destination set in step S401.

FIG. 7A illustrates a state in which the live view image 720 captured by the digital camera 100 is output to the display apparatus 700 via the cable 710 and displayed in the shooting mode.

In step S404, the system control unit 201 performs control to display, as display during a shooting standby state, information concerning shooting on the output destination set in step S401. In the example shown in FIG. 7A, an exposure parameter 721 is displayed as the information concerning shooting.

In step S406, the system control unit 201 determines whether a shooting instruction has been accepted. For example, when the shutter-release button 102 has been pressed fully or the moving image recording button 110 has been pressed, the system control unit 201 determines that a shooting instruction has been accepted. When it is determined that a shooting instruction has been accepted, the system control unit 201 advances the processing to step S408. When it is determined that no shooting instruction has been accepted, the system control unit 201 advances the processing to step S410.

In step S408, the system control unit 201 starts shooting processing for generating content. For example, when it is determined that a still image shooting instruction has been accepted by the shutter-release button 102, the system control unit 201 starts still image shooting processing, and when it is determined that a moving image recording instruction has been accepted by the moving image recording button 110, the system control unit 201 starts moving image recording processing.

In step S410, the system control unit 201 determines whether a shooting mode end instruction has been accepted. For example, when the menu button 114 has been pressed to transition to the menu mode, the reproduction button 113 has been pressed to transition to the reproduction mode, or the power supply switch 106 has been operated, the system control unit 201 determines that a shooting mode end instruction has been accepted. When it is determined that a shooting instruction has been accepted, the system control unit 201 ends the processing. When it is determined that no shooting instruction has been accepted, the system control unit 201 returns the processing to step S406, and continues the shooting processing.

### Control Processing in Reproduction Mode

The control processing in the reproduction mode in step S304 of FIG. 3 will be described next with reference to FIGS. 5 to 9.

FIGS. 5A and 5B are flowcharts illustrating the control processing in the reproduction mode in step S304 of FIG. 3.

FIGS. 7B to 7E are views illustrating transition of the connection settings when the operation mode of the digital camera 100 is switched from the shooting mode to the reproduction mode in a state in which the digital camera 100 and the display apparatus 700 are connected.

The user can rotate the sub electronic dial 107 in the clockwise direction or the counterclockwise direction, thereby setting, as content to be reproduced (to be also referred to as selected content hereinafter), content sequentially selected in accordance with the rotation direction.

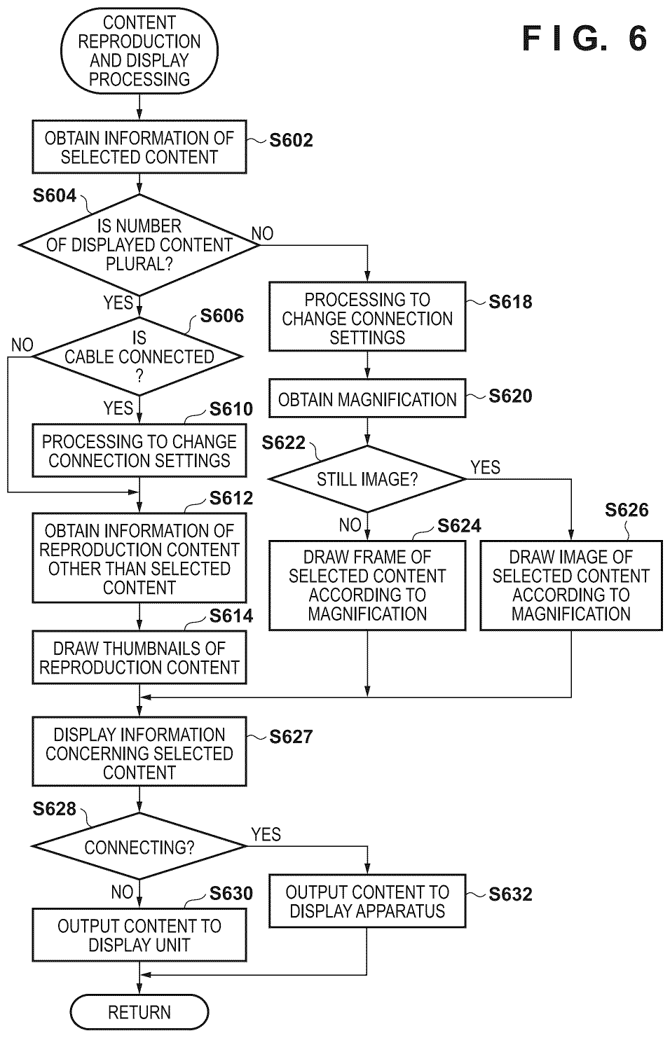

In step S502, the system control unit 201 executes reproduction and display processing of the selected content that will be described later with reference to FIG. 6.

In step S504, the system control unit 201 determines whether a selected content change instruction has been accepted in response to the operation of the sub electronic dial 107. When it is determined that a selected content change instruction has been accepted, the system control unit 201 advances the processing to step S506. When it is determined that no selected content change instruction has been accepted, the system control unit 201 advances the processing to step S512.

In step S506, the system control unit 201 changes the selected content. The system control unit 201 determines the selected content from the contents recorded in the recording medium 250 in accordance with the rotation direction of the sub electronic dial 107.

In step S508, the system control unit 201 records, in the nonvolatile memory 256, the selected content determined in step S506.

In step S510, the system control unit 201 executes the reproduction and display processing of the selected content that will be described later with reference to FIG. 6.

In step S512, the system control unit 201 determines whether a selected content enlargement instruction has been accepted in response to the operation of the enlargement/reduction button 111. When it is determined that a selected content enlargement instruction has been accepted, the system control unit 201 advances the processing to step S514. When it is determined that no selected content enlargement instruction has been accepted, the system control unit 201 advances the processing to step S532.

In step S514, the system control unit 201 determines whether the number of displayed contents recorded in the nonvolatile memory 256 is plural. The number of displayed contents is the number of contents (content count) displayed simultaneously on the screen of the display apparatus 700 or the backside display unit 101. When it is determined that the number of displayed contents is plural, the system control unit 201 advances the processing to step S516. When it is determined that the number of displayed contents is not plural, the system control unit 201 advances the processing to step S524.

In step S516, the system control unit 201 decreases the number of displayed contents. For example, when the number of displayed contents can be nine, four, or one, and the number of currently displayed contents is nine, the system control unit 201 determines, as the new number of displayed contents, four smaller than nine. The four displayed contents include the selected content and contents before and after the selected content.

In step S518, the system control unit 201 records, in the nonvolatile memory 256, the number of displayed contents determined in step S516.

In step S520, the system control unit 201 executes the reproduction and display processing of the selected content that will be described later with reference to FIG. 6.

In step S524, the system control unit 201 increases the magnification of the selected content. For example, when the magnification can be ×1 (non-enlarged state), ×2, ×4, ×6, ×8, or ×10, and the current magnification is ×4, the system control unit 201 determines, as the next magnification, a magnification of ×6 larger than ×4.

In step S526, the system control unit 201 records, in the nonvolatile memory 256, the magnification determined in step S524.

In step S528, the system control unit 201 enlarges the selected content at the magnification determined in step S524, and displays it on the output destination.

In step S532, the system control unit 201 determines whether a selected content reduction instruction has been accepted in response to the operation of the AE lock button 112. When it is determined that a selected content reduction instruction has been accepted, the system control unit 201 advances the processing to step S534. When it is determined that no selected content reduction instruction has been accepted, the system control unit 201 advances the processing to step S552.

In step S534, the system control unit 201 determines whether the selected content is enlarged and displayed. When it is determined that the selected content is enlarged and displayed, the system control unit 201 advances the processing to step S544. When it is determined that the selected content is not enlarged and displayed, the system control unit 201 advances the processing to step S536.

In step S536, the system control unit 201 increases the number of displayed contents recorded in the nonvolatile memory 256. For example, when the number of displayed contents can be nine, four, or one, and the number of currently displayed contents is four, the system control unit 201 determines, as the new number of displayed contents, nine larger than four. The nine displayed contents include the selected content and contents before and after the selected content.

In step S538, the system control unit 201 records, in the nonvolatile memory 256, the number of displayed contents determined in step S536.

In step S540, the system control unit 201 executes the reproduction and display processing of the selected content that will be described later with reference to FIG. 6.

In step S544, the system control unit 201 decreases the magnification of the selected content. For example, when the magnification can be ×1 (non-enlarged state), ×2, ×4, ×6, ×8, or ×10, and the current magnification is ×4, the system control unit 201 determines, as the next magnification, a magnification of ×2 smaller than ×4.

In step S546, the system control unit 201 records, in the nonvolatile memory 256, the magnification determined in step S544.

In step S548, the system control unit 201 enlarges the selected content at the magnification determined in step S544, and displays it on the output destination.

In step S552, the system control unit 201 determines whether the cable 710 has been connected to the connector arranged in the terminal cover 104. When it is determined that the cable 710 has been connected to the connector arranged in the terminal cover 104, the system control unit 201 advances the processing to step S554. When it is determined that the cable 710 has not been connected to the connector arranged in the terminal cover 104, the system control unit 201 advances the processing to step S556. Note that the determination of whether the cable 710 has been connected to the connector arranged in the terminal cover 104 may include determination of whether the cable 710 has been pulled out from the connector.

In step S554, the system control unit 201 executes the reproduction and display processing of the selected content that will be described later with reference to FIG. 6.

In step S556, the system control unit 201 determines whether a reproduction mode end instruction has been accepted. For example, when the menu button 114 has been pressed to transition to the menu mode, the mode selection switch 103 has been pressed to transition to the shooting mode, or the power supply switch 106 has been operated, the system control unit 201 determines that a reproduction mode end instruction has been accepted. When it is determined that a reproduction mode end instruction has been accepted, the system control unit 201 ends the processing. When it is determined that no reproduction mode end instruction has been accepted, the system control unit 201 returns the processing to step S504.

### Reproduction and Display Processing of Selected Content

The reproduction and display processing of the selected content in steps S502, S510, S520, S540, and S554 of FIGS. 5A and 5B will be described next with reference to FIG. 6.

FIG. 6 is a flowchart illustrating the reproduction and display processing of the selected content in steps S502, S510, S520, S540, and S554 of FIGS. 5A and 5B.

In step S602, the system control unit 201 obtains information of the selected content. The information of the selected content includes, for example, image data (original image/thumbnail) and information of the color gamut/gamma characteristic and the like at the time of shooting. For example, content whose color gamut and gamma characteristic are BT601 and sRGB, respectively, is Standard Dynamic Range (SDR) content recorded in a file format such as a JPEG format. Information of the SDR content is information of BT601 and sRGB. Content whose color gamut and gamma characteristic are BT2020 and PQ, respectively, is High Dynamic Range (HDR) content recorded in a file format such as a HEIF format. Information of the HDR content is information of BT2020 and PQ.

In step S604, the system control unit 201 determines whether the number of displayed contents recorded in the nonvolatile memory 256 is plural. When it is determined that the number of displayed contents is plural, the system control unit 201 advances the processing to step S606. When it is determined that the number of displayed contents is not plural, the system control unit 201 advances the processing to step S618. Note that the meaning of the number of displayed contents recorded in the nonvolatile memory 256 changes depending on at which of the timings of steps S502, S510, S520, S540, and S554 of FIGS. 5A and 5B the reproduction and display processing of the selected content shown in FIG. 6 is executed.

In step S502 of FIG. 5A, since the reproduction and display processing of the selected content is executed when the operation mode is switched from the shooting mode to the reproduction mode, the number of displayed contents reproduced at the time of previously executing the reproduction mode (at the end of the previous reproduction mode) is recorded in the nonvolatile memory 256. In step S554 of FIG. 5B, since the reproduction and display processing of the selected content is executed in response to connection of the cable 710, the number of displayed contents reproduced in the reproduction mode at the time of connection of the cable 710 is recorded in the nonvolatile memory 256. In steps S510, S520, and S540 of FIGS. 5A and 5B, the number of displayed contents currently reproduced in the reproduction mode is recorded in the nonvolatile memory 256.

In step S606, the system control unit 201 determines whether the cable 710 has been connected to the connector arranged in the terminal cover 104. When it is determined that the cable 710 has been connected to the connector arranged in the terminal cover 104, the system control unit 201 advances the processing to step S610. When it is determined that the cable 710 has not been connected to the connector arranged in the terminal cover 104, the system control unit 201 advances the processing to step S612. Note that the determination of whether the cable 710 has been connected to the connector arranged in the terminal cover 104 may include determination of whether the cable 710 has been pulled out from the connector. When the digital camera 100 is powered on by long-pressing the reproduction button 113 in a state in which the digital camera 100 and the display apparatus 700 are connected, it may be determined that the cable 710 has been connected to the connector arranged in the terminal cover 104.

In step S610, the system control unit 201 changes the connection settings of the digital camera 100 and the display apparatus 700 to connection settings suitable for the selected content. Note that when the reproduction and display processing of the selected content shown in FIG. 6 is executed in step S502 of FIG. 5A, the processing in step S610 is skipped without being executed. FIG. 7B illustrates a state while the connection settings are changed. For example, when the color gamut and gamma characteristic of the selected content are BT601 and sRGB, respectively, the color gamut and gamma characteristic of the connection settings are changed to BT601 and sRGB, respectively. When the color gamut and gamma characteristic of the selected content are BT2020 and PQ, respectively, the color gamut and gamma characteristic of the connection settings are changed to BT2020 and PQ, respectively. The display apparatus 700 is switched to a mode capable of displaying the selected content with the changed connection settings. FIG. 7B shows the display state of the display apparatus 700 while the connection settings are changed, and a screen 722 is set in a blackout state.

In step S612, the system control unit 201 obtains pieces of information of contents other than the selected content, the number of which corresponds to the number of displayed contents recorded in the nonvolatile memory 256. For example, when the number of displayed contents is four, the system control unit 201 obtains pieces of information of the remaining three contents except for the selected content.

In step S614, the system control unit 201 draws, in the memory 232, image data (thumbnail) of the selected content obtained in step S602, and image data (thumbnails) of the contents, other than the selected content, obtained in step S612. Note that when the image data include image data of a resolution higher than that of the thumbnail, the image data may be drawn. Contents the number of which is equal to the number of displayed contents recorded in the nonvolatile memory 256 are drawn.

In step S618, the system control unit 201 changes the connection settings of the digital camera 100 and the display apparatus 700 to connection settings suitable for the selected content, similar to step S610.

In step S620, the system control unit 201 obtains the magnification recorded in the nonvolatile memory 256.

In step S622, the system control unit 201 determines whether the selected content is a still image. When it is determined that the selected content is a still image, the system control unit 201 advances the processing to step S626. When it is determined that the selected content is not a still image, the system control unit 201 advances the processing to step S624.

In step S624, the system control unit 201 draws, in the memory 232, the first frame data of a moving image as the selected content for which image processing has been performed based on the magnification obtained in step S620. Since the number of displayed contents recorded in the nonvolatile memory 256 is one, one content is drawn.

In step S626, the system control unit 201 draws, in the memory 232, image data (original image data) of the still image as the selected content for which image processing has been performed based on the magnification obtained in step S620. Since the number of displayed contents recorded in the nonvolatile memory 256 is one, one content is drawn.

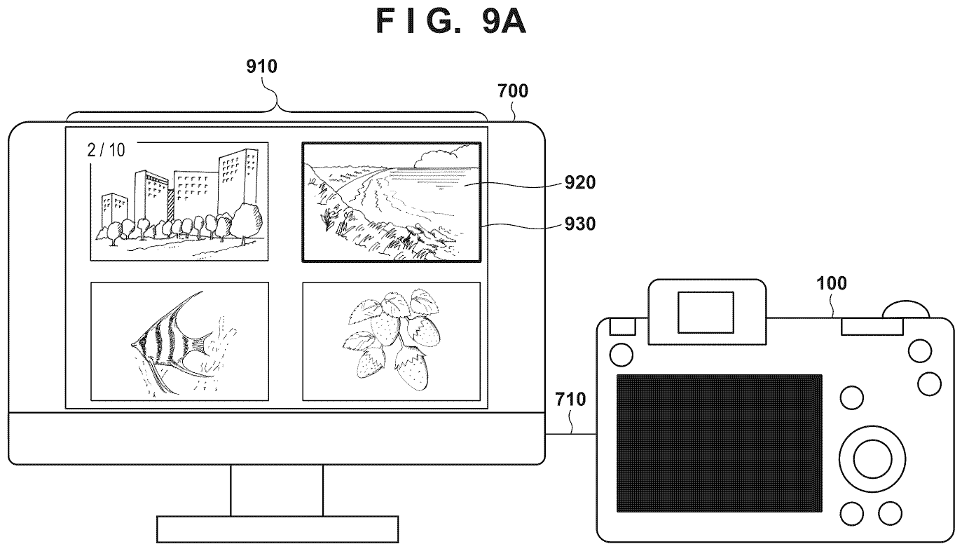

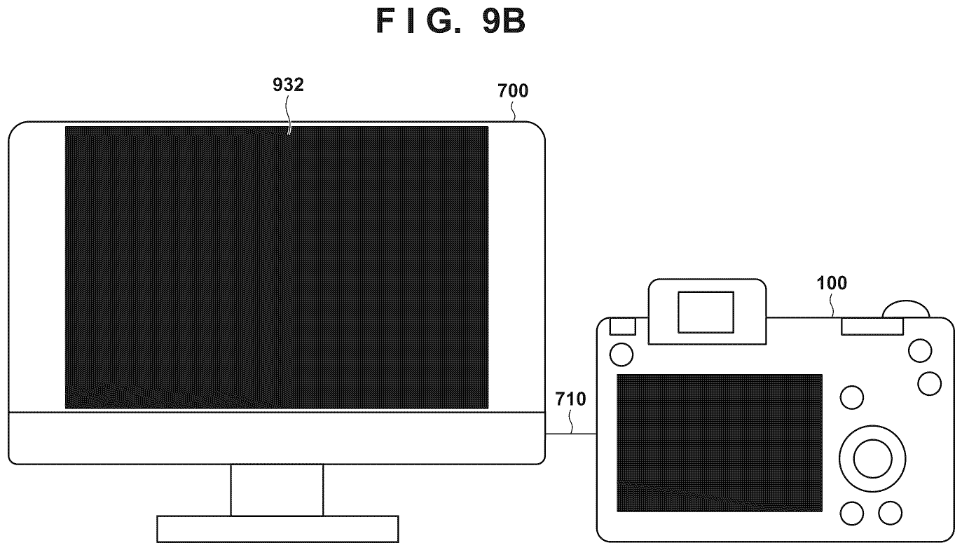

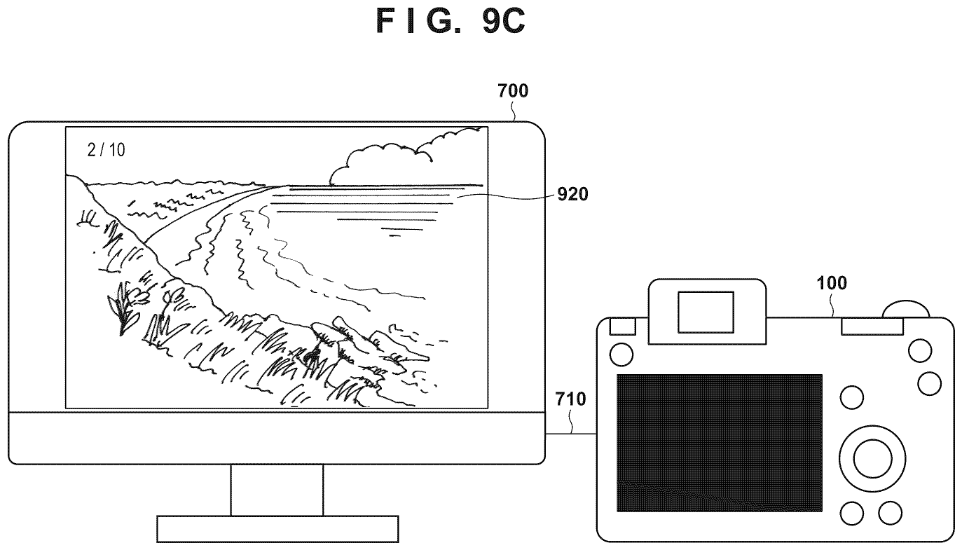

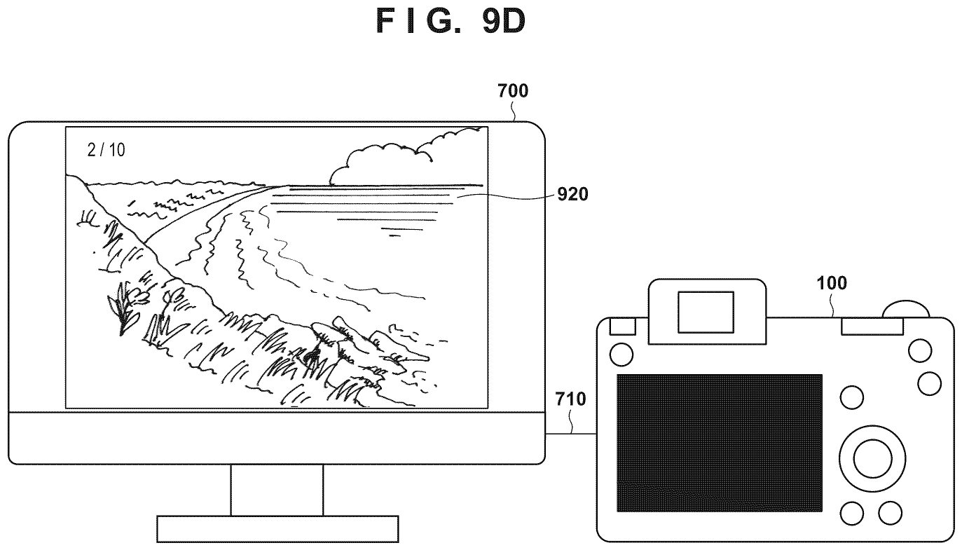

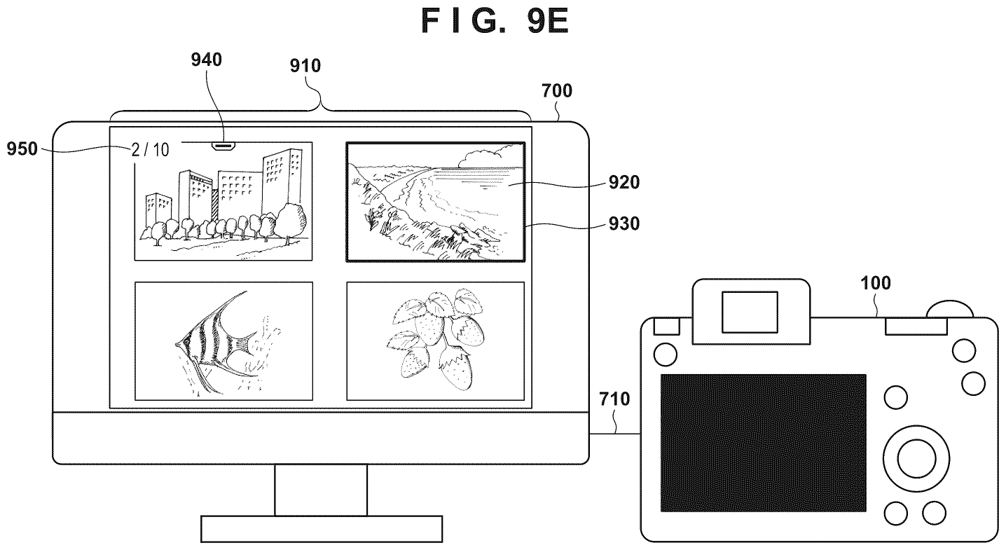

In step S627, the system control unit 201 performs control to display information concerning the selected content on the display apparatus 700, as shown in FIG. 9E. FIG. 9E illustrates a state in which a plurality of contents including the selected content are output to the display apparatus 700 via the cable 710 and displayed in the reproduction mode. An item 950 indicates the total number of contents recorded in the recording medium 250 and the number of the selected content. An icon 940 indicates that the connection settings of the selected content match the current connection settings. Note that when the current connection settings are connection settings suitable for the selected content, the icon 940 may be displayed while one content is displayed, as shown in FIG. 9D.

In step S628, the system control unit 201 determines whether the digital camera 100 is connected to the display apparatus 700 by the cable 710. When it is determined that the digital camera 100 is connected to the display apparatus 700 by the cable 710, the system control unit 201 advances the processing to step S632. When it is determined that the digital camera 100 is not connected to the display apparatus 700 by the cable 710, the system control unit 201 advances the processing to step S630.

In step S630, the system control unit 201 outputs the image data drawn in the memory 232 to the backside display unit 101.

In step S632, the system control unit 201 outputs the image data drawn in the memory 232 to the display apparatus 700.

FIG. 7C illustrates a state in which one selected content 730 is output from the digital camera 100 to the display apparatus 700 via the cable 710 and displayed in the reproduction mode.

Consider a case (steps S410, S304, and S502) where the operation mode of the digital camera 100 is switched from the shooting mode to the reproduction mode in the state shown in FIG. 7A in which the digital camera 100 and the display apparatus 700 are connected. In this case, since the number of currently displayed contents recorded in the nonvolatile memory 256 is one (NO in step S604), the connection settings are changed (step S618), and the screen 722 of the display apparatus 700 transitions to the blackout state, as shown in FIG. 7B. After that, the selected content 730 is displayed on the display apparatus 700 with the changed connection settings, as shown in FIG. 7C (step S632).

FIG. 7D illustrates a state in which the live view image 720 captured by the digital camera 100 is output to the display apparatus 700 via the cable 710 and displayed in the shooting mode. FIG. 7E illustrates a state in which four contents 740 are output from the digital camera 100 to the display apparatus 700 via the cable 710 and displayed in the reproduction mode.

Consider a case (steps S410, S304, and S502) where the operation mode of the digital camera 100 is switched from the shooting mode to the reproduction mode in the state shown in FIG. 7D in which the digital camera 100 and the display apparatus 700 are connected. In this case, since the number of currently displayed contents recorded in the nonvolatile memory 256 is plural (four) (YES in step S604), the plurality of contents 740 are displayed on the display apparatus 700 (step S632), as shown in FIG. 7E, without changing the connection settings (without executing step S610). Since the connection settings are not changed by maintaining the previous connection settings in transition of the screen from FIG. 7D to FIG. 7E, the screen does not transition to the blackout state shown in FIG. 7B.

As described above, when the number of currently displayed contents in the reproduction mode is plural, it is possible to suppress degradation in operability caused by the change of the connection settings by maintaining the already set connection settings without changing the connection settings. Alternatively, when the number of currently displayed contents in the reproduction mode is one, it is possible to faithfully express the quality of the content by changing the connection settings to connection settings suitable for the selected content.

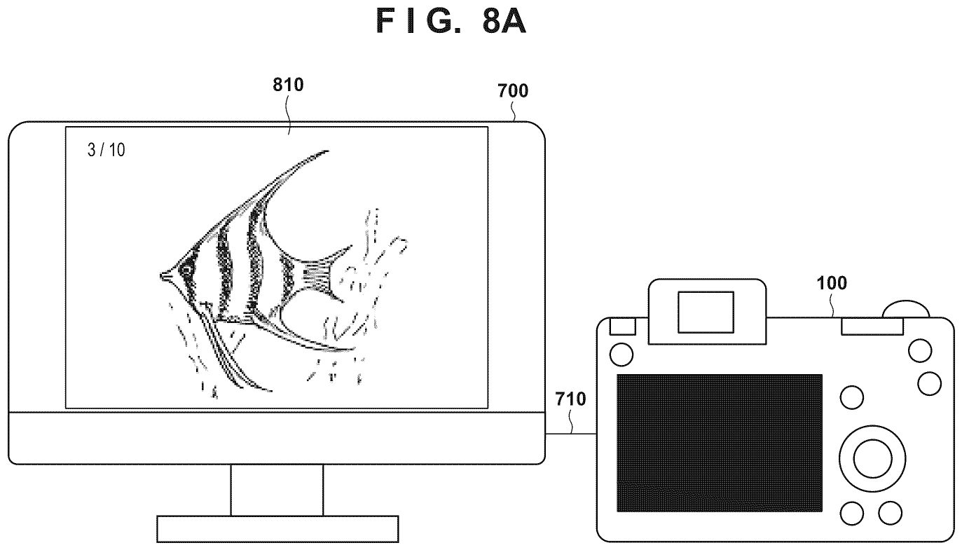

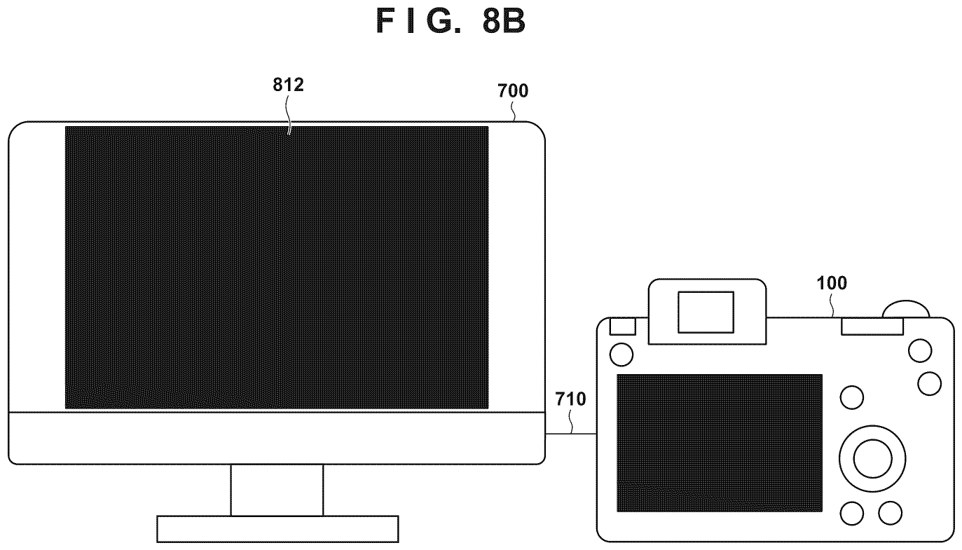

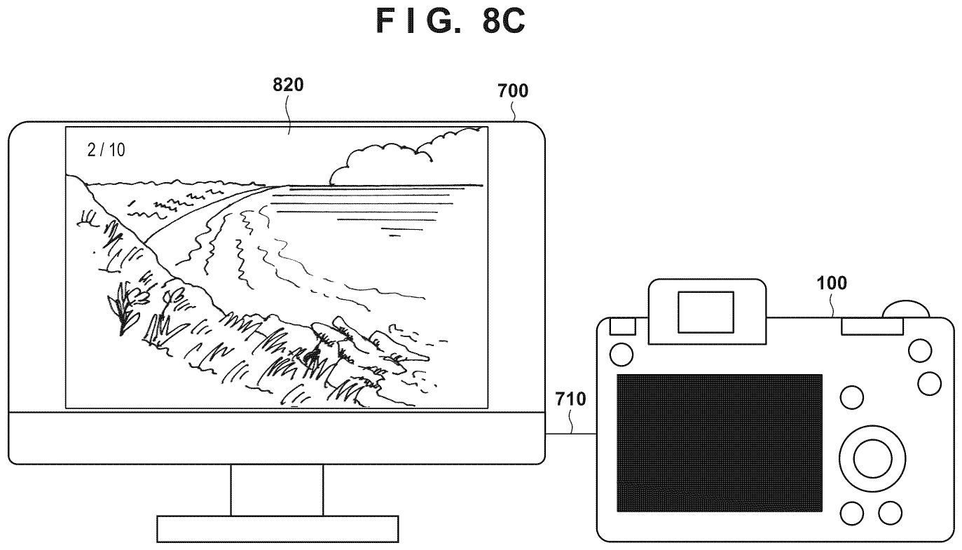

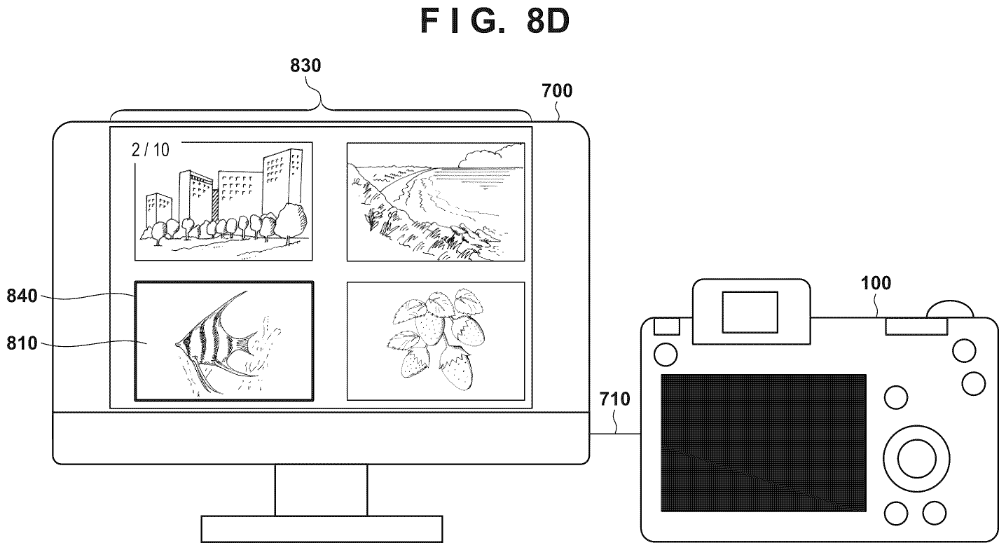

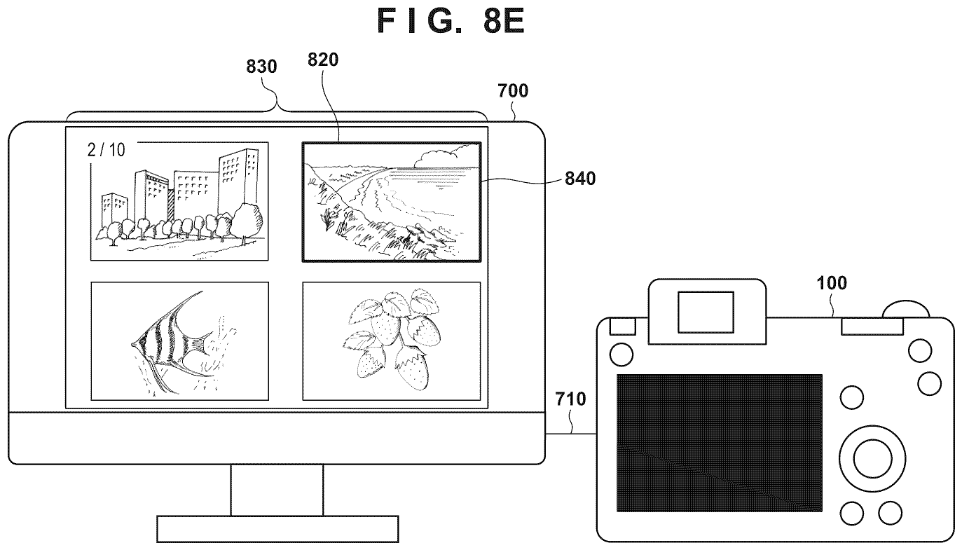

FIGS. 8A to 8E are views illustrating transition of the connection settings when the selected content is changed in the reproduction mode.

In an example shown in FIGS. 8A to 8E, selected content 810 is HDR content, and selected content 820 is SDR content.

FIG. 8A illustrates a state in which the one selected content 810 is output to the display apparatus 700 via the cable 710 and displayed in the reproduction mode. Consider a case (steps S506, S508, and S510) where the selected content is changed in the state shown in FIG. 8A in which the digital camera 100 and the display apparatus 700 are connected and the selected content 810 is currently displayed. In this case, since the number of currently displayed contents recorded in the nonvolatile memory 256 is one (NO in step S604), the connection settings are changed to connection settings suitable for the changed selected content 820 (step S618), and a screen 812 of the display apparatus 700 transitions to the blackout state, as shown in FIG. 8B. After that, the selected content 820 is displayed on the display apparatus 700 with the connection settings suitable for the selected content 820, as shown in FIG. 8C.

FIGS. 8D and 8E each illustrates a state in which four contents 830 are output to the display apparatus 700 via the cable 710 and displayed in the reproduction modes. In FIG. 8D, a selected frame 840 representing a selected content is displayed for the selected content 810.

Consider a case (steps S506, S508, and S510) where the selected content is changed in the state shown in FIG. 8D in which the digital camera 100 and the display apparatus 700 are connected and the four content 830 are currently displayed. In this case, since the number of currently displayed contents recorded in the nonvolatile memory 256 is plural (four) (YES in step S604), the plurality of contents 830 are displayed on the display apparatus 700 (step S632), as shown in FIG. 8E, without changing the connection settings (step S606). In FIG. 8E, the selected frame 840 representing the selected content is displayed for the content 820. Since the connection settings are not changed by maintaining the previous connection settings in transition of the screen from FIG. 8D to FIG. 8E, the screen does not transition to the blackout state shown in FIG. 8B.

As described above, when the number of currently displayed content in the reproduction mode is plural, when the selected content is changed, it is possible to suppress degradation in operability caused by the change of the connection settings by maintaining the already set connection settings without changing the connection settings. Alternatively, when the number of currently displayed content in the reproduction mode is one, when the selected content is changed, it is possible to faithfully express the quality of the content by changing the connection settings to connection settings suitable for the selected content.

FIGS. 9A to 9E are views illustrating transition of the connection settings when the number of displayed content is changed in the reproduction mode.

FIG. 9A illustrates a state in which four contents 910 are output to the display apparatus 700 via the cable 710 and displayed in the reproduction mode. In FIG. 9A, a selected frame 930 representing a selected content is displayed for content 920. The state shown in FIG. 9A corresponds to a case where when the setting contents are not suitable for the selected content 920 and the number of displayed contents is plural, the selected content is changed to the content 920 and the connection settings are not changed (FIGS. 8D and 8E).

Consider a case (steps S516, S518, and S520) where the number of displayed contents is changed from four to one in the state shown in FIG. 9A in which the digital camera 100 and the display apparatus 700 are currently connected. In this case, since the number of currently displayed contents recorded in the nonvolatile memory 256 is one (NO in step S604), the connection settings are changed (step S618), and a screen 932 of the display apparatus 700 transitions to the blackout state, as shown in FIG. 9B. After that, as shown in FIG. 9C, the changed selected content 920 is displayed on the display apparatus 700 with the connection settings suitable for the selected content 920. Note that when the connection settings before the change are connection settings suitable for the selected content 920, the display apparatus 700 may be controlled so the screen does not transition to the blackout state without changing the connection settings.

FIG. 9D illustrates a state in which the one selected content 920 is output to the display apparatus 700 via the cable 710 and displayed in the reproduction mode. FIG. 9E illustrates a state in which the four contents 910 are output to the display apparatus 700 via the cable 710 and displayed in the reproduction mode. In FIG. 9E, the selected frame 930 representing the selected content is displayed for the content 920.

Consider a case (steps S536 and S538) where the number of displayed contents is changed from one to four in the state shown in FIG. 9D in which the digital camera 100 and the display apparatus 700 are currently connected. In this case, since the number of currently displayed contents recorded in the nonvolatile memory 256 is plural (four), the plurality of contents 910 are displayed on the display apparatus 700 (step S540), as shown in FIG. 9E, without changing the connection settings. In the example shown in FIG. 9E, the selected frame 930 is displayed for the selected content 920. Furthermore, since the previous connection settings are maintained without changing the selected content 920, the icon 940 indicating that the connection settings are suitable for the selected content 920 is displayed.

As described above, when the number of displayed contents in the reproduction mode is changed from one to plural, it is possible to suppress degradation in operability caused by the change of the connection settings by maintaining the already set connection settings without changing the connection settings. Alternatively, when the number of displayed contents in the reproduction mode is changed from plural to one, it is possible to faithfully express the quality of the content by changing the connection settings to connection settings suitable for the selected content.

Note that when the digital camera 100 and the display apparatus 700 are connected in the reproduction mode (steps S522 and S606), the connection settings may be changed to connection settings suitable for the selected content (step S610 or S618) regardless of whether the number of currently displayed contents recorded in the nonvolatile memory 256 is one or plural (step S604), and the selected content may be displayed on the display apparatus 700 after the screen of the display apparatus 700 transitions to the blackout state.

When the contents of the connection settings remain unchanged before and after the change of the connection settings, the display apparatus 700 may be controlled so the screen of the display apparatus 700 does not transition to the blackout state.

### Control Processing in Menu Mode

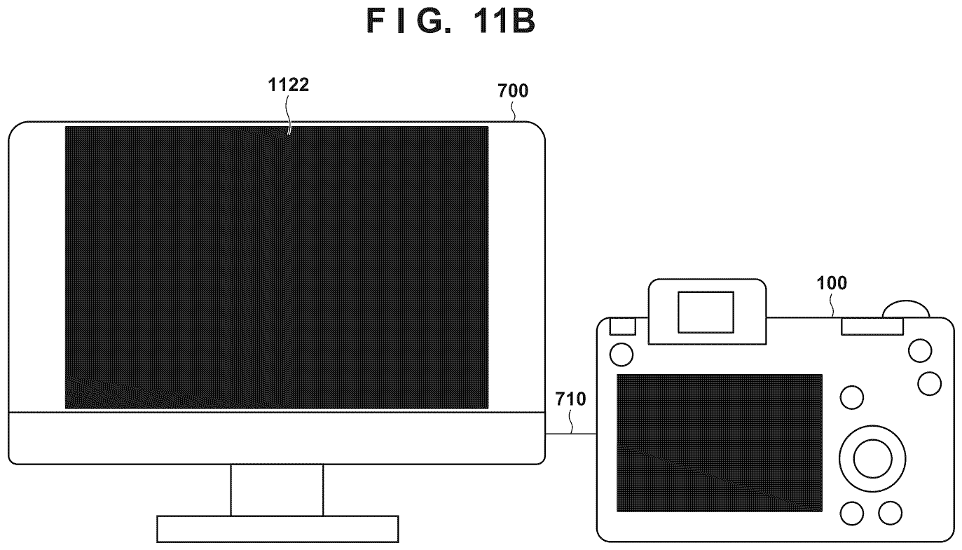

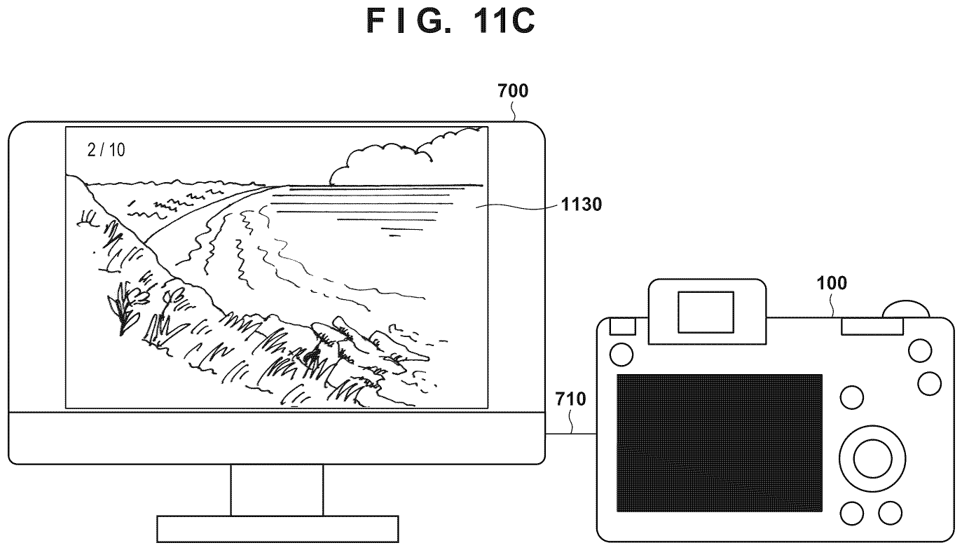

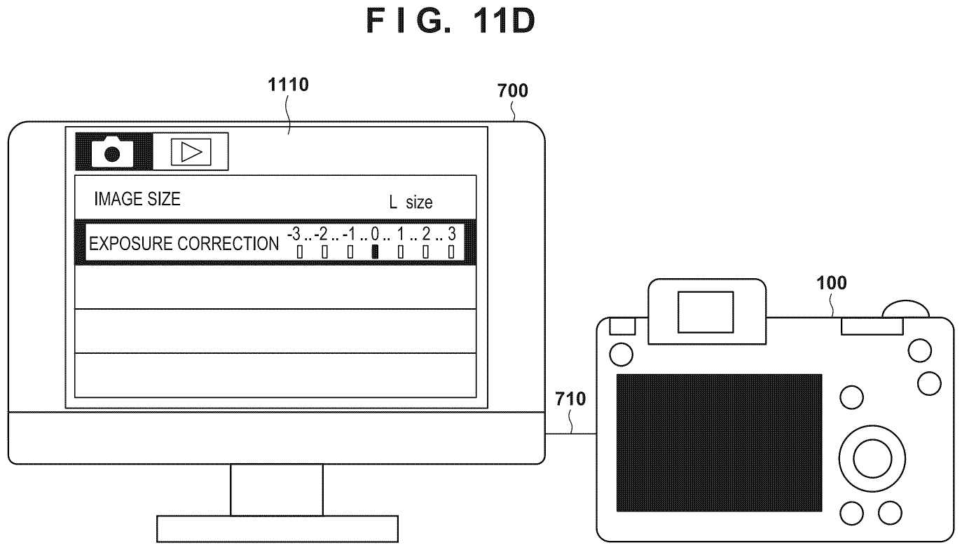

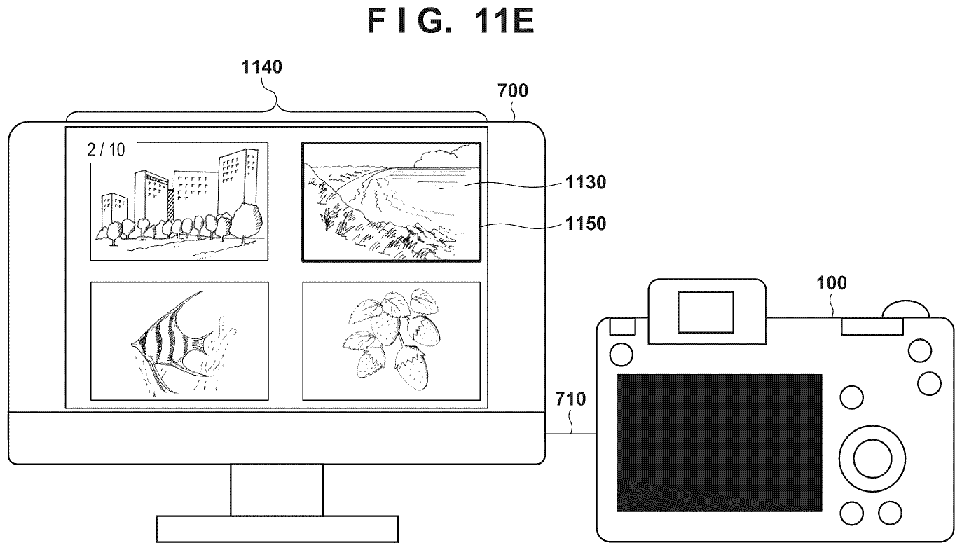

The control processing in the menu mode in step S308 of FIG. 3 will be described next with reference to FIGS. 10, 11A, and 11B.

FIG. 10 is a flowchart illustrating the control processing in the menu mode in step S308 of FIG. 3.

FIGS. 11A and 11B are views illustrating transition of the connection settings when the operation mode of the digital camera 100 is switched from the menu mode to the reproduction mode in a state in which the digital camera 100 and the display apparatus 700 are connected.

In step S1002, the system control unit 201 outputs a menu screen 1110 shown in FIG. 11A to the backside display unit 101 or the display apparatus 700 as the output destination.

In step S1004, the system control unit 201 determines whether an instruction to move a selected item has been accepted on the menu screen 1110 shown in FIG. 11A in response to the operation of the cross key 108. When it is determined that an instruction to move the selected item has been accepted, the system control unit 201 advances the processing to step S1005. When it is determined that an instruction to move the selected item has not been accepted, the system control unit 201 advances the processing to step S1006.

In step S1005, the system control unit 201 changes the selected item by moving the selected frame on the menu screen 1110 shown in FIG. 11A. In the example shown in FIG. 11A, when a selected frame 1120 is displayed for a shot image quality item, the selected frame 1120 moves to an image size item in accordance with the movement instruction of the selected item.

In step S1006, the system control unit 201 determines whether an instruction to change the settings of the digital camera 100 has been accepted in response to the operation of the sub electronic dial 107. When it is determined that an instruction to change the settings of the digital camera 100 has been accepted, the system control unit 201 advances the processing to step S1008. When it is determined that an instruction to change the settings of the digital camera 100 has not been accepted, the system control unit 201 advances the processing to step S1010.

In step S1008, the system control unit 201 changes the setting value corresponding to the selected item for which the selected frame is displayed on the menu screen 1110 shown in FIG. 11A.

In the example shown in FIG. 11A, the setting value of the exposure parameter of exposure correction for which the selected frame 1120 is displayed is changed in accordance with the setting change instruction.

In step S1010, the system control unit 201 determines whether an end instruction of the menu mode has been accepted. For example, when the menu button 114 has been pressed, the reproduction button 113 has been pressed to transition to the reproduction mode, the mode selection switch 103 has been pressed to transition to the shooting mode, or the power supply switch 106 has been operated, the system control unit 201 determines that an end instruction of the menu mode has been accepted. When it is determined that an end instruction of the menu mode has been accepted, the system control unit 201 ends the processing. When it is determined that an end instruction of the menu mode has not been accepted, the system control unit 201 returns the processing to step S1004.

FIG. 11C illustrates a state in which when the operation mode of the digital camera 100 is switched from the menu mode to the reproduction mode, one selected content 1130 is output from the digital camera 100 to the display apparatus 700 via the cable 710 and displayed.

Consider a case (steps S1010, S304, and S502) where the operation mode is switched from the menu mode to the reproduction mode in the state shown in FIG. 11A in which the digital camera 100 and the display apparatus 700 are currently connected. In this case, since the number of currently displayed contents recorded in the nonvolatile memory 256 is one (NO in step S604), the connection settings are changed (step S618), and a screen 1122 of the display apparatus 700 transitions to the blackout state, as shown in FIG. 11B. After that, the selected content 1130 is displayed on the display apparatus 700 (step S632), as shown in FIG. 11C. Note that when the connection settings before the change are connection settings suitable for the selected content 1130, the display apparatus 700 may be controlled so the screen does not transition to the blackout state without changing the connection settings.

FIG. 11D illustrates a state in which the menu screen 1110 is displayed on the display apparatus 700. FIG. 11E illustrates a state in which four contents 1140 are output from the digital camera 100 to the display apparatus 700 via the cable 710 and displayed in the reproduction mode. In FIG. 11E, a selected frame 1150 representing a selected content is displayed for the content 1130.

Consider a case (steps S1010, S304, and S502) where the operation mode is switched from the menu mode to the reproduction mode in the state shown in FIG. 11D in which the digital camera 100 and the display apparatus 700 are currently connected. In this case, since the number of currently displayed contents recorded in the nonvolatile memory 256 is plural (four) (YES in step S604), the connection settings are changed (step S606), and the four contents 1140 are displayed on the display apparatus 700 in the reproduction mode (step S632), as shown in FIG. 11E. Since the connection settings are not changed by maintaining the previous connection settings in transition of the screen from FIG. 11D to FIG. 11E, the screen does not transition to the blackout state shown in FIG. 11B.

As described above, when the number of currently displayed contents in the reproduction mode is plural, it is possible to suppress degradation in operability caused by the change of the connection settings by maintaining the already set connection settings without changing the connection settings. Alternatively, when the number of displayed contents in the reproduction mode is one, it is possible to faithfully express the quality of the content by changing the connection settings to connection settings suitable for the selected content.

Note that when the digital camera 100 is powered on by long-pressing the reproduction button 113 in a state in which the digital camera 100 and the display apparatus 700 are connected (steps S302, S304, and S502), the connection settings may be changed to connection settings suitable for the selected content (step S610 or S618) regardless of whether the number of currently displayed contents recorded in the nonvolatile memory 256 is one or plural (step S604), and the selected content may be displayed on the display apparatus 700 after the screen of the display apparatus 700 transitions to the blackout state. When the operation mode transitions from the shooting mode or the reproduction mode to the menu mode, the connection settings need not be changed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-009600, filed Jan. 25, 2024 which is hereby incorporated by reference herein in its entirety.

What is claimed is:

1. An image capture apparatus comprising:
a mode switching unit that switches to any of a plurality of operation modes including a shooting mode and a reproduction mode; and
a control unit that controls setting information concerning a display characteristic of content, which is set in the image capture apparatus and a display apparatus connected to the image capture apparatus,
wherein when the operation mode of the image capture apparatus is switched from the shooting mode to the reproduction mode,
in a case where the number of reproduced contents in the reproduction mode is one, the control unit controls to change the setting information in accordance with the reproduced content, and
in a case where the number of reproduced contents in the reproduction mode is plural, the control unit controls not to change the setting information in accordance with the reproduced contents.

2. The apparatus according to claim 1, wherein
in a case where the number of reproduced contents in the reproduction mode is plural, the control unit maintains the already set setting information.

3. The apparatus according to claim 1, further comprising:
a reproduction control unit that controls the content reproduced in the reproduction mode,
wherein in a case where the operation mode of the image capture apparatus is switched from the shooting mode to the reproduction mode, the reproduction control unit controls to reproduce contents the number of which is equal to the number of reproduced contents at an end of a previous reproduction mode.

4. The apparatus according to claim 1, further comprising:
a setting unit that sets the number of reproduced contents; and
a selection unit that selects the reproduced content.

5. The apparatus according to claim 4, wherein
the control unit changes the setting information to setting information suitable for the reproduced content in a case where the number of reproduced contents is changed from plural to one in the reproduction mode, and maintains the already set setting information in a case where the number of reproduced contents is changed from one to plural.

6. The apparatus according to claim 4, wherein
when the reproduced content is changed by the selection unit in the reproduction mode, the control unit changes the setting information to setting information suitable for the reproduced content in a case where the number of reproduced contents is one, and maintains the already set setting information in a case where the number of reproduced contents is plural.

7. The apparatus according to claim 1, wherein
the control unit transitions to the reproduction mode upon power-on of the image capture apparatus by a predetermined operation member, and controls the setting information in accordance with the reproduced content.

8. The apparatus according to claim 7, wherein
the predetermined operation member is an operation member that switches the operation mode of the image capture apparatus to the reproduction mode.

9. The apparatus according to claim 1, wherein
the control unit transitions from the shooting mode to the reproduction mode in response to connection of the display apparatus to the image capture apparatus, and controls the setting information in accordance with the reproduced content.

10. The apparatus according to claim 1, wherein
the control unit transitions to the reproduction mode upon power-on of the image capture apparatus, and controls the setting information in accordance with the reproduced content.

11. The apparatus according to claim 1, wherein
when the reproduced content is enlarged, the control unit decreases the reproduced contents in a case where the number of reproduced contents is plural, and enlarges the reproduced content in a case where the number of reproduced contents is one.

12. The apparatus according to claim 1, wherein
when the reproduced content is reduced, the control unit increases the reproduced contents in a case where the reproduced content is not enlarged and displayed, and reduces the reproduced content in a case where the reproduced content is enlarged and displayed.

13. The apparatus according to claim 1, wherein
in a case where the number of reproduced contents is plural and the contents are images, the control unit outputs thumbnails of the images to the display apparatus, and in a case where the number of reproduced contents is one and the content is an image, the control unit outputs the image to the display apparatus.

14. The apparatus according to claim 13, wherein
the image includes one of a still image and a moving image, and
in a case where the number of reproduced contents is one and the content is a still image, the control unit outputs the still image to the display apparatus, and in a case where the reproduced content is a moving image, the control unit outputs a first frame of the moving image to the display apparatus.

15. The apparatus according to claim 1, wherein
the controls unit controls to display, for the reproduced content, information indicating whether the setting information is setting information suitable for the reproduced content.

16. The apparatus according to claim 1, further comprising:
an imaging unit configured to capture an image,
wherein the control unit outputs the image captured by the imaging unit to the display apparatus in the shooting mode.

17. The apparatus according to claim 1, wherein
the operation mode of the image capture apparatus includes a menu mode of changing settings of the image capture apparatus,
when the operation mode of the image capture apparatus is switched from the menu mode to the reproduction mode, in a case where the number of reproduced contents is one, the control unit changes the setting information in accordance with the reproduced content, and
in a case where the number of reproduced contents is plural, the control unit controls not to change the setting information in accordance with the reproduced content.

18. The apparatus according to claim 1, wherein
in a case where the display apparatus is not connected to the image capture apparatus, the control unit outputs the reproduced content to a display unit provided in the image capture apparatus.

19. The apparatus according to claim 1, wherein
a screen of the display apparatus is set in a blackout state while the setting information is changed.

20. The apparatus according to claim 1, wherein
the display characteristic includes a color gamut and a gamma characteristic that can be expressed by the content.

21. The apparatus according to claim 20, wherein
the content includes High Dynamic Range (HDR) content and Standard Dynamic Range (SDR) content, and
a color gamut and a gamma characteristic of the SDR content are BT601and sRGB, respectively, and a color gamut and a gamma characteristic of the HDR content are BT2020 and PQ, respectively.

22. The apparatus according to claim 1, wherein
the image capture apparatus and the display apparatus are connected by an HDMI® cable, and
the setting information indicates HDMI connection settings.

23. A method of controlling an image capture apparatus, the method comprising:
switching to any of a plurality of operation modes including a shooting mode and a reproduction mode; and
controlling setting information concerning a display characteristic of content, which is set in the image capture apparatus and a display apparatus connected to the image capture apparatus,
wherein in the controlling, when the operation mode of the image capture apparatus is switched from the shooting mode to the reproduction mode,
in a case where the number of reproduced contents in the reproduction mode is one, control is performed to change the setting information in accordance with the reproduced content, and
in a case where the number of reproduced contents in the reproduction mode is plural, control is performed not to change the setting information in accordance with the reproduced content.

24. A non-transitory computer-readable storage medium storing a program for causing a computer to function as the image capture apparatus comprising:
a mode switching unit that switches to any of a plurality of operation modes including a shooting mode and a reproduction mode; and
a control unit that controls setting information concerning a display characteristic of content, which is set in the image capture apparatus and a display apparatus connected to the image capture apparatus,
wherein when the operation mode of the image capture apparatus is switched from the shooting mode to the reproduction mode,
in a case where the number of reproduced contents in the reproduction mode is one, the control unit controls to change the setting information in accordance with the reproduced content, and
in a case where the number of reproduced contents in the reproduction mode is plural, the control unit controls not to change the setting information in accordance with the reproduced contents.
